(19) United States
(12) Patent Application Publication
(10) Pub. No.: US 2025/0184837 A1
(43) Pub. Date: Jun. 5, 2025

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/045,144

(22) Filed: Feb. 4, 2025

Related U.S. Application Data
(63) Continuation of application No. PCT/JP2023/028081, filed on Aug. 1, 2023.
(60) Provisional application No. 63/395,095, filed on Aug. 4, 2022.

(51) Int. Cl. H04W 36/00; H04W 36/08; H04W 76/19

(52) U.S. Cl. CPC H04W 36/0061; H04W 36/08; H04W 76/19

(57) ABSTRACT

In an aspect, a communication control method is used in a cellular communication system. The communication control method includes transmitting, by one of a donor node or an intermediate relay node that is stationary without movement, information about a mobile relay node.

### RELATED APPLICATIONS

The present application is a continuation based on PCT Application No. PCT/JP2023/028081, filed on Aug. 1, 2023, which claims the benefit of U.S. Provisional Patent Application No. 63/395,095 filed on Aug. 4, 2022. The content of which is incorporated by reference herein in their entirety.

### TECHNICAL FIELD

The present disclosure relates to a communication control method used in a cellular communication system.

### BACKGROUND

The Third Generation Partnership Project (3GPP), which is a standardization project for cellular communication systems, has studied the introduction of a new relay node called Integrated Access and Backhaul (IAB) node (for example, see Non-Patent Document 1). One or more relay nodes are involved in communication between a base station and user equipment to perform relay for the communication.

### CITATION LIST

### Non-Patent Literature

Non-Patent Document 1: 3GPP TS 38.300 V17.1.0 (2022-06)

### SUMMARY

In a first aspect, a communication control method is used in a cellular communication system. The communication control method includes a step of transmitting, by one of a donor node or an intermediate relay node that is stationary without movement, information about a mobile relay node.

In a second aspect, a communication control method is used in a cellular communication system. The communication control method includes transmitting, by a mobile relay node, information about the mobile relay node.

In a third aspect, a communication control method is used in a cellular communication system. The communication control method includes transmitting, by a source donor node, a handover request message including information indicating that a mobile relay node is a handover target to a target donor node. The communication control method includes selecting, by the target donor node, a cell managed by the target donor node as a handover destination cell of the mobile relay node in response to reception of the handover request message.

### BRIEF DESCRIPTION OF THE DRAWINGS

FIG. 1 is a diagram illustrating a configuration example of a cellular communication system according to an embodiment.

FIG. 2 is a diagram illustrating a relationship between IAB nodes, parent nodes, and child nodes.

FIG. 3 is a diagram illustrating a configuration example of a gNB (base station) according to an embodiment.

FIG. 4 is a diagram illustrating a configuration example of an IAB node (relay node) according to an embodiment.

FIG. 5 is a diagram illustrating a configuration example of user equipment (UE) according to an embodiment.

FIG. 6 is a diagram illustrating an example of a protocol stack related to an RRC connection and a NAS connection of an IAB-MT.

FIG. 7 is a diagram illustrating an example of a protocol stack related to an F1-U protocol.

FIG. 8 is a diagram illustrating an example of a protocol stack related to an F1-C protocol.

FIG. 9 is a diagram illustrating an example of a first scenario according to a first embodiment.

FIG. 10 is a diagram illustrating an example of a second scenario according to the first embodiment.

FIG. 11 is a diagram illustrating an operation example according to a first operation example.

FIG. 12 is a diagram illustrating an operation example according to a second operation example.

FIG. 13 is a diagram illustrating an operation example according to a third operation example.

FIG. 14 is a diagram illustrating an operation example according to a fourth operation example.

FIG. 15 is a diagram illustrating an operation example according to a fifth operation example.

FIG. 16 is a diagram illustrating an operation example according to a sixth operation example.

FIG. 17 is a diagram illustrating an operation example according to a seventh operation example.

FIG. 18 is a diagram illustrating an operation example according to an eighth operation example.

FIG. 19 is a diagram illustrating an operation example according to a ninth operation example.

FIG. 20 is a diagram illustrating an operation example according to a tenth operation example.

FIG. 21 is a diagram illustrating an operation example according to an 11th operation example.

### DESCRIPTION OF EMBODIMENTS

A cellular communication system according to an embodiment is described with reference to the drawings. In the description of the drawings, the same or similar parts are denoted by the same or similar reference signs.

### First Embodiment

### Configuration of Cellular Communication System

A configuration example of the cellular communication system according to an embodiment will be described. In an embodiment, a cellular communication system 1 is a 5G system of the 3GPP. Specifically, a radio access scheme of the cellular communication system is New Radio (NR) being a 5G radio access scheme. Note that Long Term Evolution (LTE) may be at least partially applied to the cellular communication system 1. A future cellular communication system such as 6G may be applied to the cellular communication system 1.

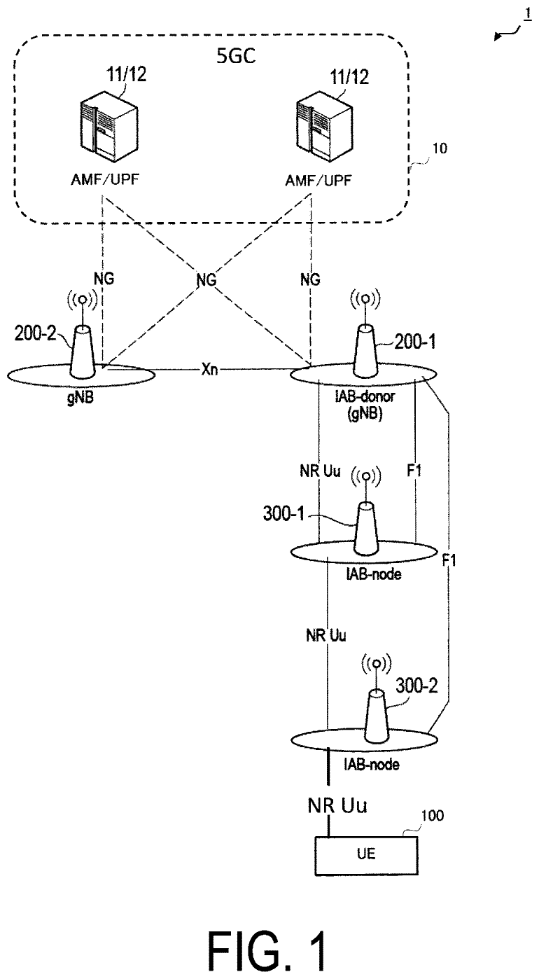

FIG. 1 is a diagram illustrating a configuration example of the cellular communication system 1 according to an embodiment.

As illustrated in FIG. 1, the cellular communication system 1 includes a 5G core network (5GC) 10, user equipment (UE) 100, base station apparatuses (hereinafter, which may also be referred to as “base stations”) 200-1 and 200-2, and IAB nodes 300-1 and 300-2. The base stations 200 may be referred to as gNBs.

Although an example in which the base stations 200 are NR base stations will be mainly described below, the base stations 200 may be LTE base stations (i.e., eNBs).

Note that, in the following description, the base stations 200-1 and 200-2 may be referred to as gNBs 200 (or base stations 200), and the IAB nodes 300-1 and 300-2 may be referred to as IAB nodes 300.

The 5GC 10 includes an Access and Mobility Management Function (AMF) 11 and a User Plane Function (UPF) 12. The AMF 11 controls various types of mobility and the like for the UE 100. The AMF 11 manages information of the area in which the UE 100 exists in by communicating with the UE 100 using Non-Access Stratum (NAS) signaling. The UPF 12 controls user data transfer, and the like.

Each gNB 200 is a fixed wireless communication node and manages one or more cells. The term “cell” is used as a term representing a minimum unit of a wireless communication area. The “cell” is also used as a term representing a function or a resource for performing wireless communication with the UE 100. One cell belongs to one carrier frequency. Hereinafter, cells and base stations may be used without distinction.

Each gNB 200 is interconnected to the 5GC 10 via an interface referred to as an NG interface. FIG. 1 illustrates two nodes of the gNB 200-1 and the gNB 200-2 connected to the 5GC 10.

Each gNB 200 may be divided into a Central Unit (CU) and a Distributed Unit (DU). The CU and the DU are interconnected via an interface called an F1 interface. An F1 protocol is a communication protocol between the CU and the DU and includes an F1-C protocol that is a control plane protocol and an F1-U protocol that is a user plane protocol.

The cellular communication system 1 supports an IAB that uses NR for the backhaul to enable wireless relay of the NR access. The donor gNB 200-1 (or a donor node, which hereinafter may be also referred to as a “donor node”) is a donor base station that is a terminal node of the NR backhaul on the network side and includes additional functionality for supporting the IAB. The backhaul can implement multi-hop via a plurality of hops (i.e., a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted in two backhaul hops.

The UE 100 is a mobile wireless communication apparatus that performs wireless communication with cells. The UE 100 may be any type of apparatus as long as the UE 100 is an apparatus that performs wireless communication with the gNBs 200 or the IAB nodes 300. For example, the UE 100 includes a mobile phone terminal or a tablet terminal, a laptop PC, a sensor or an apparatus that is provided in a sensor, a vehicle or an apparatus that is provided in a vehicle, and an aircraft or an apparatus provided in an aircraft. The UE 100 is wirelessly connected to any of the IAB nodes 300 or the gNBs 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

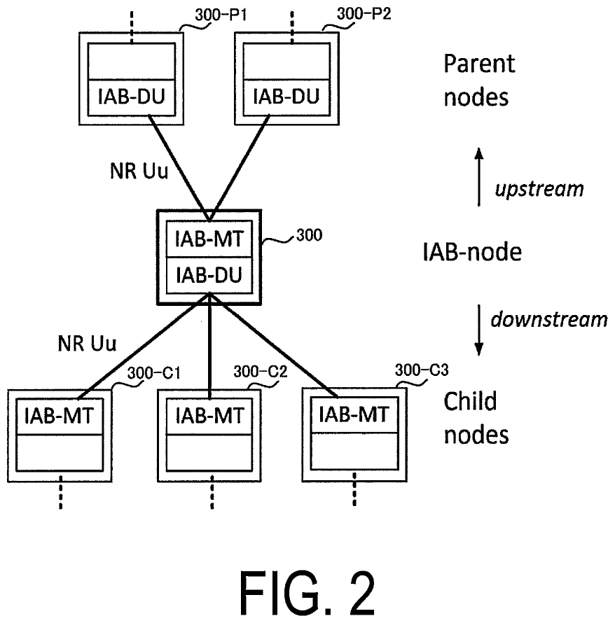

FIG. 2 is a diagram illustrating a relationship example between the IAB nodes 300, parent nodes, and child nodes.

As illustrated in FIG. 2, the IAB nodes 300 are an IAB-DU corresponding to a base station functional unit and an IAB-Mobile Termination (IAB-MT) corresponding to a user equipment functional unit, respectively.

Neighboring nodes of the IAB-MT (i.e., upper node) on an NR Uu wireless interface are referred to as “parent nodes”. The parent nodes are parent IAB nodes or DUs of the donor nodes 200. A radio link between the IAB-MT and each parent node is referred to as a backhaul link (BH link). FIG. 2 illustrates an example in which the parent nodes of the IAB nodes 300 are IAB nodes 300-P1 and 300-P2. Note that the direction toward the parent nodes is referred to as upstream. As viewed from the UE 100, the upper nodes with respect to the UE 100 may correspond to parent nodes.

Neighboring nodes of the IAB-DU (i.e., lower nodes) of an NR access interface are referred to as “child nodes”. The IAB-DU manages cells like the gNB 200. The IAB-DU terminates the NR Uu wireless interface connected to the UE 100 and the lower IAB nodes. The IAB-DU supports the F1 protocol for the CU of the donor node 200-1. Although FIG. 2 illustrates an example in which the child nodes of the IAB nodes 300 are IAB nodes 300-C1 to 300-C3, the child nodes of the IAB nodes 300 may include the UE 100. Note that the direction toward the child nodes is referred to as downstream.

All of the IAB nodes 300 connected to the donor node 200 via one or more hops form a Directed Acyclic Graph (DAG) topology (which may be referred to as “topology” below) rooted at the donor node 200. In this topology, the neighboring nodes of the IAB-DU on the interface are child nodes, and the neighboring nodes of the IAB-MT on the interface are parent nodes as illustrated in FIG. 2. The donor nodes 200 perform, for example, centralized management on resources, topology, and routes of the IAB topology. The donor nodes 200 are gNBs that provide network access to the UE 100 via a network of backhaul links and access links.

### Configuration of Base Station

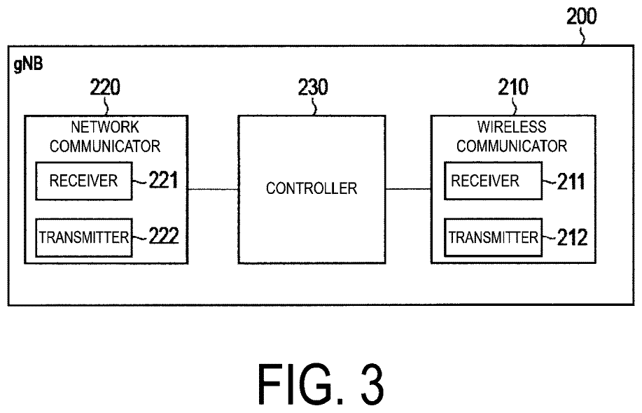

A configuration of a gNB 200 as a base station according to an embodiment will be described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and performs wireless communication with the IAB nodes 300. The wireless communicator 210 includes a receiver 211 and a transmitter 212. The receiver 211 performs various types of reception under control of the controller 230. The receiver 211 includes an antenna and converts (down-converts) a radio signal received by the antenna into a baseband signal (reception signal) and then outputs the signal to the controller 230. The transmitter 212 performs various types of transmission under control of the controller 230. The transmitter 212 includes an antenna and converts (up-converts) the baseband signal (transmission signal) output by the controller 230 into a radio signal and then transmits the signal from the antenna.

The network communicator 220 performs wired communication (or wireless communication) with the 5GC 10 and performs wired communication (or wireless communication) with another neighboring gNB 200. The network communicator 220 includes a receiver 221 and a transmitter 222. The receiver 221 performs various types of reception under control of the controller 230. The receiver 221 receives a signal from outside and outputs the reception signal to the controller 230. The transmitter 222 performs various types of transmission under control of the controller 230. The transmitter 222 transmits the transmission signal output by the controller 230 to the outside.

The controller 230 performs various types of controls for the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. Note that the controller 230 may perform all of the processing and operations in the gNB 200 in each embodiment to be described below.

### Configuration of Relay Node

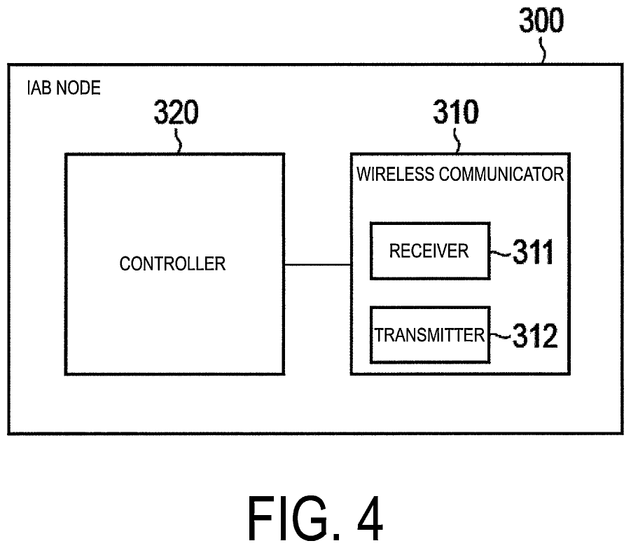

A configuration of the IAB node 300 that is a relay node (or a relay node apparatus, which may hereinafter also be referred to as a “relay node”) according to an embodiment will be described. FIG. 4 is a diagram illustrating a configuration example of the IAB node 300. As illustrated in FIG. 4, the IAB node 300 includes a wireless communicator 310 and a controller 320. The IAB node 300 may include a plurality of wireless communicators 310.

The wireless communicator 310 performs wireless communication with the gNB 200 (BH link) and wireless communication with the UE 100 (access link). A wireless communicator 310 for BH link communication and a wireless communicator 310 for access link communication may be provided separately.

The wireless communicator 310 includes a receiver 311 and a transmitter 312. The receiver 311 performs various types of reception under control of the controller 320. The receiver 311 includes an antenna and converts (down-converts) a radio signal received by the antenna into a baseband signal (reception signal) and then outputs the signal to the controller 320. The transmitter 312 performs various types of transmission under control of the controller 320. The transmitter 312 includes an antenna and converts (up-converts) the baseband signal (transmission signal) output by the controller 320 into a radio signal and then transmits the signal from the antenna.

The controller 320 performs various types of control in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of each layer described below. Note that the controller 320 may perform each processing and operation in the IAB node 300 in each embodiment to be described below.

### Configuration of User Equipment

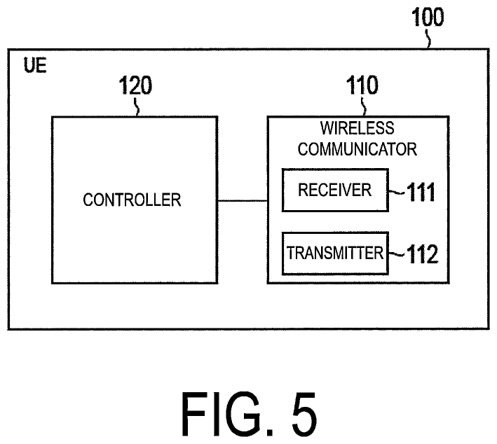

A configuration of the UE 100 that is user equipment according to an embodiment will be described. FIG. 5 is a diagram illustrating a configuration example of the UE 100. As illustrated in FIG. 5, the UE 100 includes a wireless communicator 110 and a controller 120.

The wireless communicator 110 performs wireless communication in access links, i.e., wireless communication with the gNBs 200 and wireless communication with the IAB nodes 300. The wireless communicator 110 may also perform wireless communication in sidelink, i.e., wireless communication with another piece of UE 100. The wireless communicator 110 includes a receiver 111 and a transmitter 112. The receiver 111 performs various types of reception under control of the controller 120. The receiver 111 includes an antenna and converts (down-converts) a radio signal received by the antenna into a baseband signal (reception signal) and then outputs the signal to the controller 120. The transmitter 112 performs various types of transmission under control of the controller 120. The transmitter 112 includes an antenna and converts (up-converts) the baseband signal (transmission signal) output by the controller 120 into a radio signal and then transmits the signal from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of each layer described below. Note that the controller 120 may perform each processing operation in the UE 100 in each embodiment described below.

### Configuration of Protocol Stack

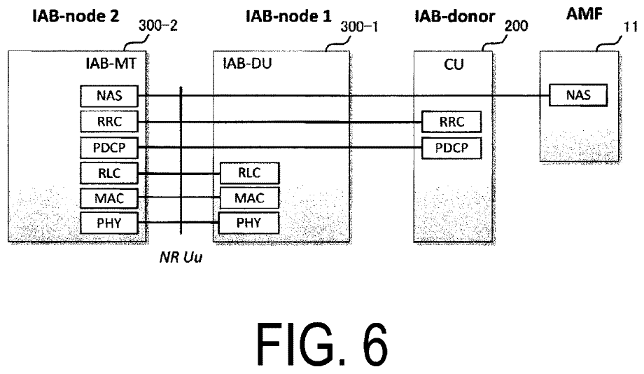

A configuration of a protocol stack according to an embodiment will be described. FIG. 6 is a diagram illustrating an example of a protocol stack related to an RRC connection and a NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through a Hybrid Automatic Repeat reQuest (HARQ), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines uplink and downlink transport formats (transport block sizes, Modulation and Coding Schemes (MCSs)) and allocated resource blocks.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a physical channel.

The PDCP layer performs header compression/decompression, and encryption/decryption. Data and control information are transmitted between the PDCP layer of the IAB-MT of the IAB node 300-2 and the PDCP layer of the donor node 200 via a radio bearer

The RRC layer controls a logical channel, a transport channel, and a physical channel according to establishment, reestablishment, and release of a radio bearer. RRC signaling for various configurations is transmitted between the RRC layer of the IAB-MT of the IAB node 300-2 and the RRC layer of the donor node 200. When an RRC connection to the donor node 200 is present, the IAB-MT is in an RRC connected state. When no RRC connection to the donor node 200 is present, the IAB-MT is in an RRC idle state.

The NAS layer positioned above the RRC layer performs session management, mobility management, and the like. NAS signaling is transmitted between the NAS layer of the IAB-MT of the IAB node 300-2 and the AMF 11.

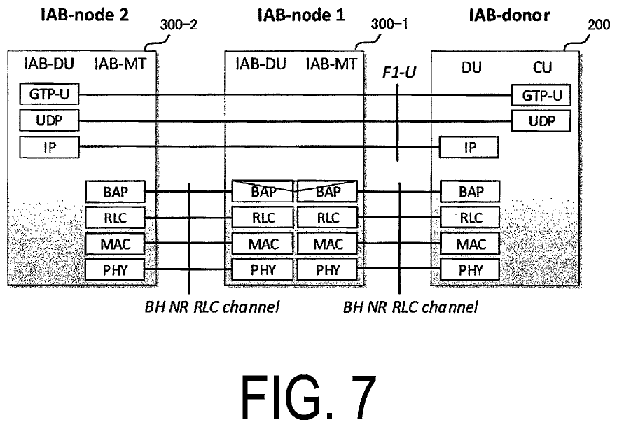

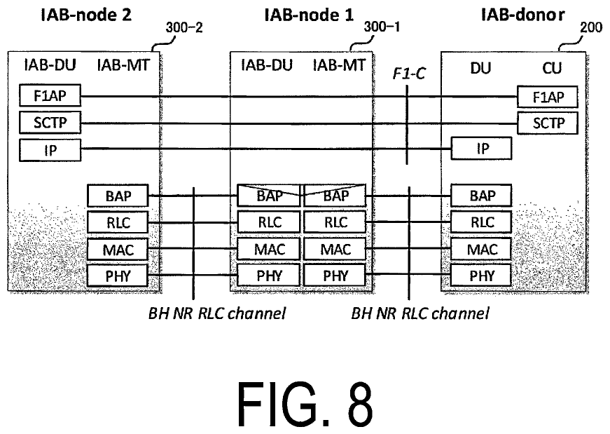

FIG. 7 is a diagram illustrating a protocol stack related to an F1-U protocol. FIG. 8 is a diagram illustrating a protocol stack related to an F1-C protocol. An example in which the donor node 200 is divided into a CU and a DU will be introduced here.

As illustrated in FIG. 7, each of the IAB-MT of the IAB node 300-2, the IAB-DU of the IAB node 300-1, the IAB-MT of the IAB node 300-1, and the DU of the donor node 200 includes a Backhaul Adaptation Protocol (BAP) layer as an upper layer of the RLC layer. The BAP layer performs routing processing, and bearer mapping/demapping processing. In the backhaul, transmission of the IP layer through the BAP layer enables routing through a plurality of hops.

In each backhaul link, a Protocol Data Unit (PDU) of the BAP layer is transmitted by a backhaul RLC channel (BH NR RLC channel). Configuring a plurality of backhaul RLC channels in each BH link enables the prioritization and Quality of Service (QOS) control of traffic. Association between the BAP PDU and the backhaul RLC channel is executed by the BAP layer of each IAB node 300 and the BAP layer of the donor node 200.

As illustrated in FIG. 8, the protocol stack of the F1-C protocol includes an F1AP layer and an SCTP layer instead of a GTP-U layer and a UDP layer illustrated in FIG. 7.

Note that in the description below, processing or operation performed by the IAB-DU and the IAB-MT of the IAB may be simply described as processing or operation of the “IAB”. For example, in the description, transmitting, by the IAB-DU of the IAB node 300-1, a message of the BAP layer to the IAB-MT of the IAB node 300-2 is assumed to correspond to transmitting, by the IAB node 300-1, the message to the IAB node 300-2. Processing or operation of the DU or CU of the donor node 200 may be described simply as processing or operation of the “donor node”.

An upstream direction and an uplink (UL) direction may be used without distinction. A downstream direction and a downlink (DL) direction may be used without distinction.

### Two Scenarios

Recently, the 3GPP has started a study for introducing mobile IAB nodes. A mobile IAB node is, for example, an IAB node that is moving. A mobile IAB node may be a movable IAB node. Alternatively, a mobile IAB node may be an IAB node having the ability to move. Alternatively, a mobile IAB node may be an IAB node that is currently stationary but is certain to move in the future (or is expected to move in the future).

By the mobile IAB node, for example, the UE 100 under the control of the mobile IAB node can receive provision of services from the mobile IAB node while moving with the movement of the mobile IAB node. For example, a user (or UE 100) riding in a vehicle can receive provision of a service via a mobile IAB node installed in the vehicle.

Note that the 3GPP also has discussed that a mobile IAB node should provide services to UE 100 without having an IAB node under its control.

On the other hand, there is an IAB node that does not move with respect to the mobile IAB node. Such an IAB node may be referred to as an intermediate IAB node. The intermediate IAB node is, for example, a non-moving IAB node. Alternatively, the intermediate IAB node may be an IAB node that is still. The intermediate IAB node may be a stationary IAB node. Alternatively, the intermediate IAB node may be a stationary (or non-moving) IAB node installed at the installation site. Alternatively, the intermediate IAB node may be an IAB node that is stationary without movement. Alternatively, the intermediate IAB node may be a fixed IAB node.

The 3GPP has studied the complexity of a mobile IAB node in each of the following two scenarios.

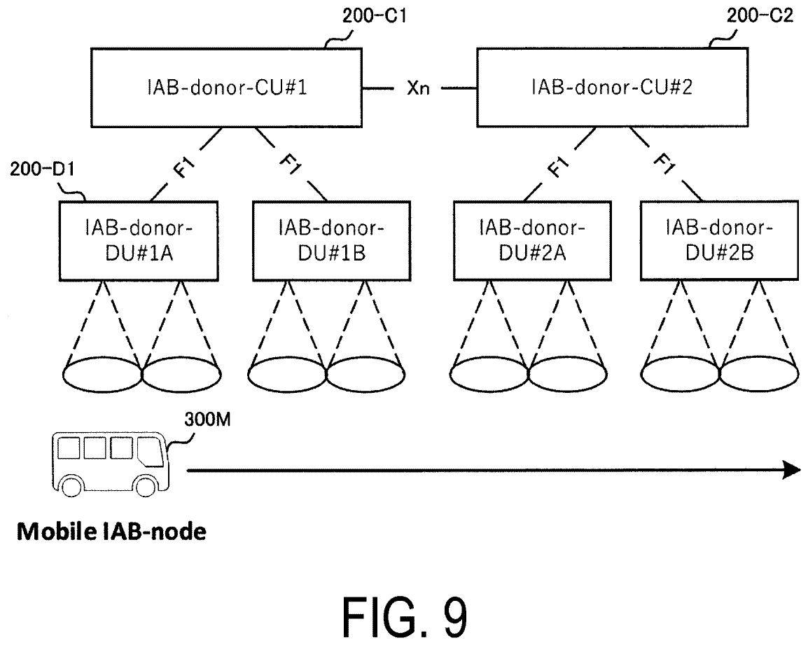

(First scenario) A mobile IAB node connects only to a donor node. (Second scenario) A mobile IAB node can also connect to an intermediate IAB node. FIG. 9 is a diagram illustrating an example of the first scenario according to a first embodiment. The example of FIG. 9 indicates a mobile IAB node 300M installed on a bus and moving while being connected to a DU (DU 200-D1, etc.) of each of donor nodes 200 (which may be referred to as “IAB-donor-DU”). In the first scenario, the mobile IAB node 300M connects to the donor nodes 200 without connecting to an intermediate IAB node. “Connect only to the donor node” means connecting to the donor nodes 200 without connecting to an intermediate IAB node.

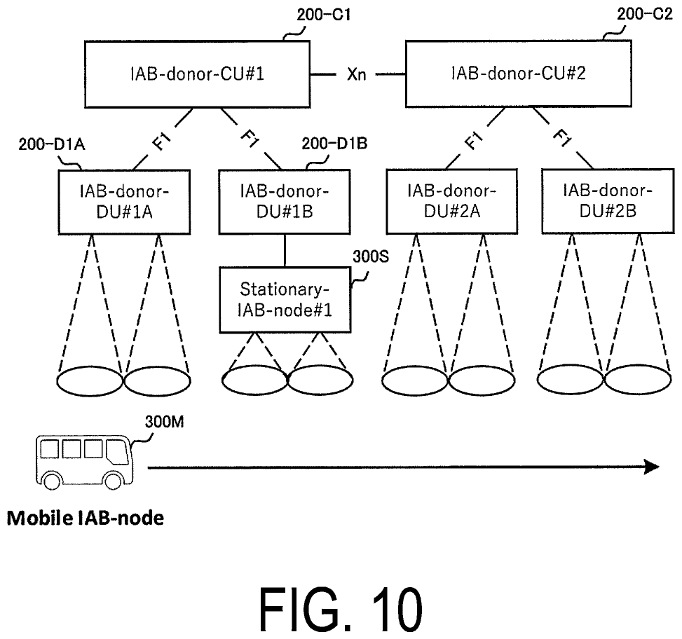

FIG. 10 is a diagram illustrating an example of the second scenario according to the first embodiment. The example of FIG. 10 indicates a mobile IAB node 300M installed on a bus and moving while being connected to each DU (DU 200-D1A or the like) of each donor node 200 (which may be referred to as an “IAB-donor-DU”) and also connected to an intermediate IAB node 300S (an IAB-DU included in the intermediate IAB node 300S). The second scenario is of the mobile IAB node 300M being connectable to the donor node 200 and to the intermediate IAB node 300S.

The 3GPP has some opinions that the first scenario is less complex than the second scenario, and conversely, that the first scenario is more complex than the second scenario.

The first embodiment will describe the first scenario. In the first scenario, for example, when the mobile IAB node 300M cannot be connected to the donor node 200, if the mobile IAB node 300M is considered to have been disconnected from the network, the mobile IAB node 300M is assumed to be incapable of providing a service to the UE 100 under its control. However, if the mobile IAB node 300M can be connected to the donor node 200, it can properly provide services to the UE 100.

Therefore, an object of the first embodiment is to enable the mobile IAB node 300M to properly connect to the donor node 200.

Five operation examples according to the first embodiment will be described in order below.

(1.1) First operation example: The donor node 200 broadcasts connection grant information of the mobile IAB node 300M.

(1.2) Second operation example: The intermediate IAB node 300S broadcasts connection rejection information of the mobile IAB node 300M.

(1.3) Third operation example: A serving cell sets a list from which a cell can be selected for the mobile IAB node 300M.

(1.4) Fourth operation example: The mobile IAB node 300M is capable of selecting a cell among cells involved in measurement configuration or conditional reconfiguration.

(1.5) Fifth operation example: The donor node 200 broadcasts a PRACH resource that can be used exclusively by the mobile IAB node 300M.

Note that the first operation example to the fifth operation example are examples in which one of a donor node (for example, the donor node 200) and an intermediate relay node (for example, the intermediate IAB node 300S) that is stationary without movement transmits information about a mobile relay node (for example, the mobile IAB node 300M). The information about a mobile relay node is different in each operation example. A specific example of the information about a mobile relay node will be described in each operation example.

### (1.1) First Operation Example

A first operation example will be described first.

The first operation example is of the donor node 200 broadcasting connection grant information of the mobile IAB node 300M. The connection grant information is, for example, information indicating that connection of the mobile relay node (for example, the mobile IAB node 300M) is granted. In the first operation example, the information about the mobile relay node (for example, the mobile IAB node 300M) is connection grant information. In the first operation example, the donor node (for example, the donor node 200) broadcasts the connection grant information.

Thus, for example, the mobile IAB node 300M having received the connection grant information can recognize that the cell of the donor node 200 having broadcast the connection grant information is a connectable cell. The mobile IAB node 300M can connect to the donor node 200 by connecting to the cell. Thus, the mobile IAB node 300M can properly connect to the donor node 200.

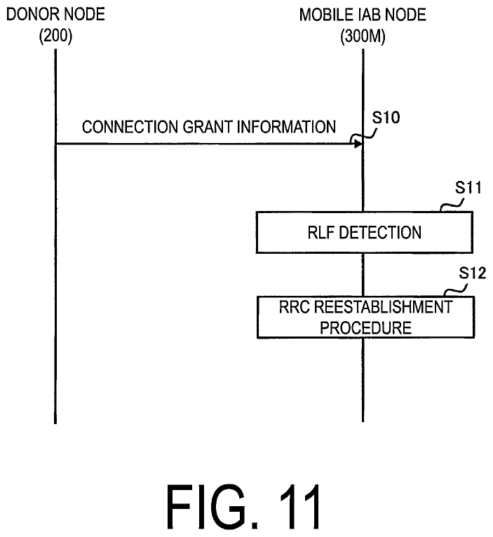

FIG. 11 is a diagram illustrating an operation example according to the first operation example.

As illustrated in FIG. 11, in step S10, the donor node 200 starts connection grant information. The donor node transmits the connection grant information by broadcasting a system information block (SIB) including the connection grant information. The mobile IAB node 300M receives the connection grant information.

The connection grant information may be information indicating that connection of the mobile IAB node 300M is granted. Alternatively, the connection grant information may be information indicating that the node broadcasting the connection grant information is the donor node 200 (or the cell of the donor node 200). Alternatively, the connection grant information may be information indicating that the mobile IAB node 300M is supported. The cell broadcasting the connection grant information may support the mobile IAB node 300M and may be considered as a candidate cell to be selected by the mobile IAB node 300M. Note that the connection grant information is a subject of notification by, for example, an information element “Mobile-IAB-Supported”. The connection grant information is an information element different from “IAB-Supported” which is an existing information element. The mobile IAB node 300M may determine that access to the cell is possible when an SIB notifies the node of both “Mobile-IAB-Supported” and “IAB-Supported”. Alternatively, when the SIB has notified the mobile IAB node 300M of “Mobile-IAB-Supported” (regardless of whether a notification of “IAB-Supported” has been given), the mobile IAB node 300M may determine that access to the cell is possible.

Note that the CU of the donor node 200 (IAB-donor-CU) may select the DU of the donor node 200 (IAB-donor-DU) that grants a connection of the mobile IAB node 300M, and transmit an F1 message including access connection grant information to the selected DU of the donor node 200. In response to the reception of the F1 message, the DU of the donor node 200 may broadcast an SIB (for example, SIB 1) including connection grant information. In this case, the CU of the donor node 200 does not transmit an F1 message including the connection grant information to the DU of the intermediate IAB node 300S which does not grant a connection of the mobile IAB node 300M.

In step S11, the mobile IAB node 300M detects a Radio Link Failure (RLF). An RLF may be detected when the mobile IAB node 300M detects a radio problem or expiration of a timer for a measurement report. Alternatively, when the IAB-MT of the mobile IAB node 300M receives a backhaul radio link failure indication (BH RLF Indication) from the donor node 200, the mobile IAB node 300M may detect an RLF.

In step S12, the mobile IAB node 300M performs an RRC Reestablishment procedure. When the mobile IAB node 300M starts performing the RRC Reestablishment procedure, it first performs a cell selection procedure to select a suitable cell. At this time, the mobile IAB node 300M sets the cell having broadcast the connection grant information (step S10) as a selection candidate cell in the cell selection procedure. Alternatively, the mobile IAB node 300M may preferentially select the cell having broadcast the connection grant information. Alternatively, the mobile IAB node 300M may exclude a cell broadcasting no connection grant information from selection candidates. Then, the mobile IAB node 300M selects the highest-quality cell from the selection candidates. The mobile IAB node 300M transmits an RRC reestablishment request (RRCReestablishmentRequest) message to the cell to start performing the RRC reestablishment procedure.

Note that, for example, before step S10, the mobile IAB node 300M receives the cell ID of the cell from the donor node 200 when establishing synchronization with the cell managed by the donor node 200. Therefore, the mobile IAB node 300M can determine the cell having broadcast the connection grant information based on the cell ID.

### (1.2) Second Operation Example

The second operation example will be described. Differences of the second operation example from the first operation example will be mainly described.

The second operation example is of the intermediate IAB node 300S broadcasting connection rejection information of the mobile IAB node 300M. To be more specific, information about the mobile relay node (for example, the mobile IAB node 300M) is connection rejection information indicating that a connection of the mobile relay node is not granted. The intermediate relay node (for example, the intermediate IAB node 300S) broadcasts the connection rejection information.

As a result, for example, the mobile IAB node 300M can ascertain a cell to which connection of the mobile IAB node 300M itself is not granted. Therefore, the mobile IAB node 300M can avoid connecting to the cell managed by the intermediate IAB node 300S. Thus, the mobile IAB node 300M can properly connect to the donor node 200.

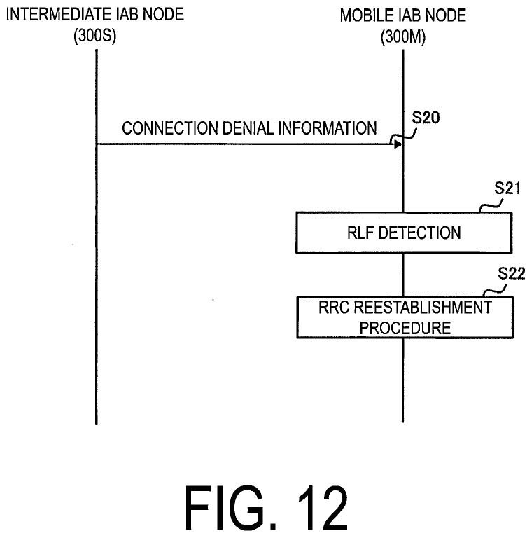

FIG. 12 is a diagram illustrating an operation example according to the second operation example.

As illustrated in FIG. 12, the intermediate IAB node 300S broadcasts connection rejection information in step S20. The intermediate IAB node 300S broadcasts an SIB (e.g., SIB 1) including the connection rejection information. The mobile IAB node 300M receives the connection rejection information.

The connection rejection information may be information indicating that a connection of the mobile IAB node 300M is not allowed. Alternatively, the connection rejection information may be information indicating that the node broadcasting the connection rejection information is the intermediate IAB node 300S (or the cell of the intermediate IAB node 300S). Alternatively, the connection rejection information may be information indicating that the mobile IAB node 300M is not supported. The cell broadcasting the connection rejection information may be a cell not supporting the mobile IAB node 300M and not considered as a candidate cell to be selected by the mobile IAB node 300M. Note that, for example, an information element “Mobile-IAB-Not-Allowed” is used to give a notification of the connection rejection information. The mobile IAB node 300M determines that access to the cell is prohibited (or the cell does not support a connection of the mobile IAB node 300M) when the notification of “Mobile-IAB-Not-Allowed” is given even though the existing information element “IAB-Supported” has been given as a notification.

Note that the CU of the donor node 200 may select a DU (intermediate IAB-DU) of the intermediate IAB node 300S which does not grant a connection of the mobile IAB node 300M and transmit the F1 message including connection rejection information with respect to the selected DU. The DU of the intermediate IAB node 300S may broadcast the SIB including the connection rejection information in response to reception of the F1 message. In this case, the CU of the donor node 200 does not transmit the F1 message including the connection rejection information to the DU of the donor node 200 that grants a connection of the mobile IAB node 300M.

In step S21, the mobile IAB node 300M detects an RLF as in the first operation example.

In step S22, the mobile IAB node 300M performs an RRC reestablishment procedure. As in the first operation example, the mobile IAB node 300M first performs a cell selection procedure to select a suitable cell. At this time, the mobile IAB node 300M excludes the cell having broadcast the connection rejection information (step S20) from selection candidate cells in the cell selection procedure. The mobile IAB node 300M may set a cell broadcasting no connection rejection information as a selection candidate. The mobile IAB node 300M selects the highest-quality cell from the selection candidates. Then, the mobile IAB node 300M transmits an RRC reestablishment request message to the selected cell and starts execution of the RRC reestablishment procedure.

Note that the mobile IAB node 300M can be connected to, for example, the cell of the intermediate IAB node 300S. When establishing synchronization with the cell managed by the intermediate IAB node 300S, the mobile IAB node 300M receives the cell ID of the cell from the cell. Therefore, the mobile IAB node 300M can determine the cell having broadcast the connection rejection information by associating the cell ID with the connection rejection information (step S20) included in the SIB.

### Third Operation Example

The third operation example will be described. Differences of the third operation example from the first operation example will be mainly described as well.

In the third operation example, when the mobile IAB node 300M connects to one of the cell managed by the donor node 200 and the cell managed by the intermediate IAB node, the cell (i.e., serving cell) sets a list of selectable cells for the mobile IAB node 300M.

To be more specific, information about the mobile relay node (for example, the mobile IAB node 300M) is connectable cell information indicating a cell to which the mobile relay node can connect. One of the donor node (e.g., donor node 200) or the intermediate relay node (e.g., intermediate IAB node 300S) transmits the connectable cell information to the mobile relay node.

As a result, for example, the mobile IAB node 300M can ascertain the cell to which the mobile IAB node 300M can connect. By setting the cell managed by the donor node 200 as the cell to which the mobile IAB node 300M can connect, the mobile IAB node 300M having received the connectable cell information can properly connect to the donor node 200.

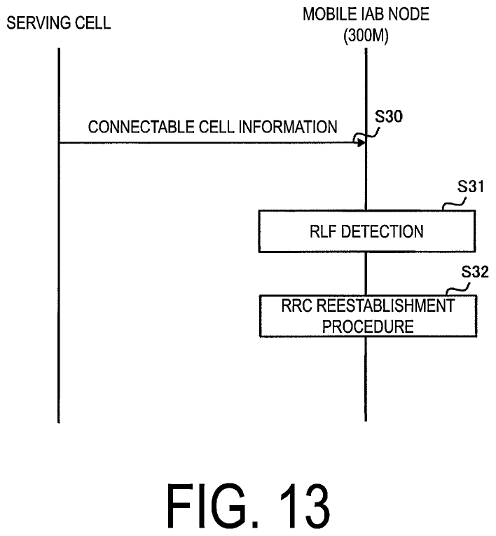

FIG. 13 is a diagram illustrating an operation example according to the third operation example. Note that, before starting the operation illustrated in FIG. 13, the mobile IAB node 300M may connect to the cell managed by the donor node 200. Alternatively, before starting the operation illustrated in FIG. 13, the mobile IAB node 300M may connect to the cell managed by the intermediate IAB node 300S. The serving cell illustrated in FIG. 13 may be the cell managed by the donor node 200. The serving cell may be the cell managed by the intermediate IAB node 300S.

However, when the mobile IAB node 300M connects to the cell managed by the intermediate IAB node, the mobile IAB node can immediately perform handover to the cell managed by the donor node 200 by receiving an RRC reconfiguration (RRCReconfiguration) (HO command) message from the cell managed by the intermediate IAB node.

As illustrated in FIG. 13, in step S30, the serving cell transmits, to the mobile IAB node 300M, connectable cell information indicating a cell to which the mobile IAB node 300M can connect. The connectable cell information may indicate cell IDs of connectable cells in the form of a list (as an Allowed list). The serving cell may transmit non-connectable cell information to the mobile IAB node 300M, the non-connectable cell information indicating a cell to which the mobile IAB node 300M cannot connect (or a non-connectable cell). The non-connectable cell information may indicate cell IDs of non-connectable cells in the form of a list (as a Block list) as well. The serving cell may transmit an RRC reconfiguration (RRCReconfiguration) message including the connectable cell information (or the non-connectable cell information) to the mobile IAB node 300M.

Note that the serving cell may update the connectable cell information (or the non-connectable cell information) when various events occur.

For example, the serving cell may be configured with the updated connectable cell information at the time of handover of the mobile IAB node 300M. The updated connectable cell information may be included in the RRC reconfiguration (HO command) message and transmitted.

For example, when a secondary cell group (SCG) is changed with dual connectivity configured in the mobile IAB node 300M, the connectable cell information may be updated. The master node (serving cell) may transmit an RRC reconfiguration message including the updated connectable cell information to configure the updated connectable cell information.

In step S31, the mobile IAB node 300M detects an RLF as in the first operation example.

In step S32, the mobile IAB node 300M starts an RRC reestablishment procedure. The mobile IAB node 300M first performs a cell selection procedure. The mobile IAB node 300M sets the cell included in the connectable cell information as a selection candidate cell in the cell selection procedure. The mobile IAB node 300M may preferentially select the cell included in the connectable cell information. On the other hand, the mobile IAB node 300M excludes the cell indicated by the non-connectable cell information from the selection candidate cells in the cell selection procedure. The mobile IAB node 300M selects the highest-quality cell from the selection candidates. Then, the mobile IAB node 300M transmits an RRC reestablishment request message to the selected cell.

### (1.4) Fourth Operation Example

The fourth operation example will be described. Differences of the fourth operation example from the first operation example will be mainly described as well.

The fourth operation example is to determine which a cell included in a measurement configuration or a conditional reconfiguration as a connectable cell of the mobile IAB node 300M.

In particular, information about a mobile relay node (for example, the mobile IAB node 300M) is cell identification information (e.g. a cell ID) included in one of a measurement configuration or a conditional reconfiguration. First, a donor node (e.g., donor node 200) transmits one of a measurement configuration or a conditional reconfiguration to the mobile relay node. Second, the mobile relay node determines the cell indicated by the cell identification information included in one of the measurement configuration or the conditional reconfiguration as a cell to which the mobile relay node can connect.

Thus, for example, assuming that the cell ID included in one of the measurement configuration or the conditional reconfiguration is a cell managed by the donor node 200, the mobile IAB node 300M can select the cell indicated by the cell ID in the cell selection procedure. Therefore, the mobile IAB node 300M can properly connect to the donor node 200.

The measurement configuration and the conditional reconfiguration are also transmitted to the mobile IAB node 300M in an RRC message, for example an RRC reconfiguration (RRCReconfiguration) message. Therefore, the donor node 200 can notify the mobile IAB node 300M of a cell to which the mobile IAB node 300M can connect by using an existing message.

The measurement configuration is one of information elements (IEs) included in an RRC message, such as an RRC reconfiguration message. The measurement configuration includes configuration information for the mobile IAB node 300M to perform a measurement report. Particularly, the measurement configuration includes information about a cell serving as a measurement object. In the third operation example, the cell included in the measurement object is treated as a connectable cell for the mobile IAB node 300M.

The conditional reconfiguration is, for example, one of the information elements included in the RRC reconfiguration message. The conditional reconfiguration includes configuration information when the mobile IAB node 300M performs conditional handover (CHO). The conditional handover is a handover performed when one or more handover execution conditions are met. In particular, the conditional reconfiguration includes information of a candidate target cell (target SpCell). In the third operation example, the cell included in the conditional reconfiguration is treated as a connectable cell for the mobile relay node.

Then, the mobile IAB node 300M sets the cell included in one of the measurement configuration or the conditional reconfiguration as a selection candidate cell in the cell selection procedure. By setting the cell included in one of the measurement configuration or the conditional reconfiguration as a cell managed by the donor node 200, the mobile IAB node 300M can connected to the donor node 200.

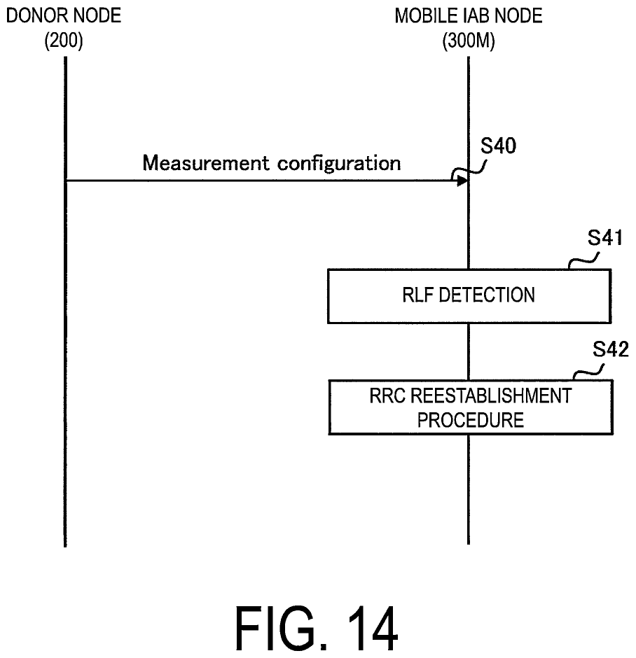

FIG. 14 is a diagram illustrating an operation example according to the fourth operation example.

As illustrated in FIG. 14, the donor node 200 sets a measurement configuration for the mobile IAB node 300M in step S40. In particular, the donor node 200 transmits an RRC message including the measurement configuration to the mobile IAB node 300M.

The measurement configuration includes one or more cell IDs. The measurement configuration may include information indicating that the mobile IAB node 300M can connect in association with the cell IDs. The mobile IAB node 300M recognizes the cell indicated by a cell ID included in the measurement configuration as a cell to which the mobile IAB node 300M can connect.

In step S41, the mobile IAB node 300M detects an RLF as in the first operation example.

In step S42, the mobile IAB node 300M starts performing an RRC reestablishment procedure. The mobile IAB node 300M first performs a cell selection procedure. At this time, the mobile IAB node 300M sets the cell (or cell ID) included in the measurement configuration as a selection candidate cell. The mobile IAB node 300M selects the highest-quality cell from the selection candidates and transmits an RRC reestablishment request message to the selected cell.

Note that, although the example of the measurement configuration has been described in the operation example illustrated in FIG. 14, the operation can be similarly performed for a conditional reconfiguration. That is, the donor node 200 can set a conditional reconfiguration for a conditional handover for the mobile IAB node 300M by transmitting an RRC reconfiguration message including the conditional reconfiguration to the mobile IAB node 300M (step S40). After detecting an RLF (step S41), the mobile IAB node 300M sets the cell indicated by the cell ID included in the conditional reconfiguration as a connectable cell and as a selection candidate in the cell selection procedure (step S42).

### (1.5) Fifth Operation Example

The fifth operation example will be described. Differences of the fifth operation example from the first operation example will be mainly described as well.

The fifth operation example is of the donor node 200 broadcasting a PRACH resource that can be used exclusively by the mobile IAB node 300M.

In particular, information about a mobile relay node (e.g. the mobile IAB node 300M) is resource information about resources that the mobile relay node can use exclusively in a random access procedure. The donor node (for example, the donor node 200) broadcasts the resource information.

On the other hand, the mobile IAB node 300M can recognize the cell having broadcast the resource information as a cell to which the mobile IAB node itself can connect. The mobile IAB node 300M can set the cell as a selection candidate cell in the cell selection procedure. The mobile IAB node 300M uses the resource information to transmit a message (Msg1 or the like) to the cell selected from the selection candidates, thereby performing the random access procedure.

In this way, the mobile IAB node 300M recognizes the cell broadcasting the resource information as a cell to which the mobile IAB node 300M can connect. For this reason, the mobile IAB node 300M can properly connect to the donor node 200 by setting the cell broadcasting the resource information as the cell managed by the donor node 200. It is assumed in the mobile IAB node 300M that a serving cell change process such as a handover or RRC reestablishment frequently occurs due to movement of the mobile IAB node itself, in comparison to the intermediate IAB node 300S. By providing the mobile IAB node 300M with a PRACH resource different from that of the intermediate IAB node 300S, PRACH collision can be avoided or radio resources can be effectively utilized.

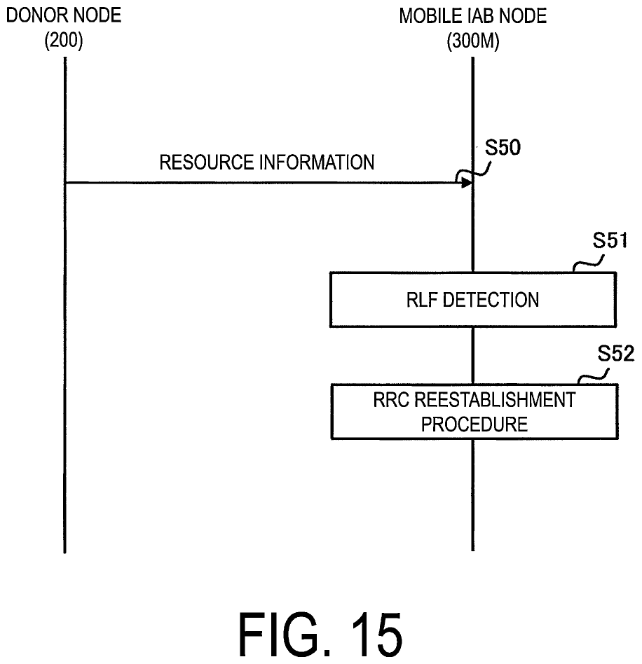

FIG. 15 is a diagram illustrating an operation example according to the fifth operation example.

As illustrated in FIG. 15, the donor node 200 broadcasts resource information in step S50. The resource information is, for example, information about resources that the mobile IAB node 300M can use exclusively in a random access procedure. The resource information is used, for example, when the IAB-MT of the mobile IAB node 300M performs the random access procedure. The DU of the donor node 200 may broadcast an SIB (e.g., SIB 1) including the resource information. The mobile IAB node 300M receives the broadcast resource information.

Note that the CU of the donor node 200 may select a DU (IAB-donor-DU) that provides resources dedicated to the mobile IAB node 300M, and notify the DU of the selection as a DU that provides resources dedicated to the mobile IAB node 300M. The CU of the donor node 200 may perform the notification by transmitting an F1 message including information indicating the selection to the DU of the donor node 200. Upon receiving the notification, the DU of the donor node 200 may broadcast the SIB including the resource information. The CU of the donor node 200 does not perform the notification to the DU of the intermediate IAB node 300S.

In step S51, the mobile IAB node 300M detects an RLF as in the first operation example.

In step S52, the mobile IAB node 300M starts performing an RRC reestablishment procedure. The mobile IAB node 300M first initiates a cell selection procedure to set a cell that has broadcast the resource information as a selection candidate. The mobile IAB node 300M may exclude a cell broadcasting no resource information from selection candidates. The mobile IAB node 300M selects the cell with the highest radio quality from the selection candidates. The mobile IAB node 300M transmits Msg1 to the selected cell by using the resources indicated by the resource information, and transmits an RRC reestablishment request message (for example, Msg3).

### Other Example of First Embodiment

Although it has been described that the connection grant information is used in the cell selection procedure in the RRC reestablishment procedure in the first operation example, the present disclosure is not limited thereto. The connection grant information may be used in a general cell selection procedure in addition to the RRC reestablishment procedure. The connection grant information may be used in a cell reselection procedure. That is, the IAB-MT of the mobile IAB node 300M may set the cell to which the connection grant information has been broadcast as the cell selection procedure or a selection candidate cell in the cell selection procedure. Alternatively, the IAB-MT of the mobile IAB node 300M may preferentially select the cell to which the connection grant information has been broadcast in the cell selection procedure or the cell selection procedure.

The fifth operation example may also be used in a general cell selection procedure other than the RRC reestablishment procedure, and may also be used in a cell reselection procedure. That is, the IAB-MT of the mobile IAB node 300M may set the cell to which the resource information has been broadcast as the cell selection procedure or a selection candidate cell in the cell reselection procedure. Alternatively, the IAB-MT of the mobile IAB node 300M may preferentially select the cell to which the resource information has been broadcast in the cell selection procedure or the cell selection procedure.

The second operation example may also be used in a general cell selection procedure other than the RRC reestablishment procedure, and may also be used in a cell reselection procedure. That is, the IAB-MT of the mobile IAB node 300M may exclude the cell to which a connection rejection information has been broadcast from the selection candidate cells in the cell selection procedure or the cell reselection procedure.

### Second Embodiment

A second embodiment will be described.

The second embodiment is also an example to which the first scenario is applied. In particular, initial access will be described in the second embodiment.

The first scenario is that the mobile IAB node 300M only connects to the donor node 200. For example, it is assumed that the mobile IAB node 300M has moved to a cell managed by the intermediate IAB node 300S. In such a case, when the mobile IAB node 300M tries to connect to the cell managed by the intermediate IAB node 300S, the connection itself may be rejected from the beginning in consideration of the first scenario.

However, considering that the mobile IAB node 300M is one of network nodes, it may be preferable to have the mobile IAB node 300M connected to the intermediate IAB node 300S and then to the donor node 200 rather than a connection to the intermediate IAB node 300S being rejected from the beginning.

Therefore, in the second embodiment, a case in which the mobile IAB node 300M is allowed to connect to the intermediate IAB node 300S and then connects to the donor node 200 according to the first scenario will be described. In such a case, it is assumed that the following processing is performed.
The mobile IAB node 300M performs a handover to the donor node 200 upon connecting to the intermediate IAB node 300S.
When the mobile IAB node 300M is restricted not to operate as the mobile IAB node 300M when connecting to the intermediate IAB node 300S.

The second embodiment will be described below including the above processing.

Note that, in the second embodiment, the mobile IAB node 300M eventually connects to the donor node 200. For this reason, the second embodiment also aims at enabling the mobile IAB node 300M to properly connect to the donor node 200, similarly to the first embodiment.

The second embodiment will be described in the following order.

(2.1) Sixth operation example: The mobile IAB node 300M identifies itself as a mobile IAB node at the time of connection.

(2.2) Seventh operation example: The donor node 200 restricts the mobile IAB node 300M for F1 setup.

(2.3) Eighth operation example: The mobile IAB node 300M transmits an F1 message to the donor node 200 to indicate whether the mobile IAB node can operate as a mobile IAB node.

(2.4) Ninth operation example: The mobile IAB node 300M transmits information for specifying an RRC connection to the donor node 200 with an F1 message.

Note that the sixth to ninth operation examples include an example in which a mobile relay node (for example, the mobile IAB node 300M) transmits information related to the mobile relay node. What the information about the mobile relay node is about will be described in each operation example.

### (2.1) Sixth Operation Example

The sixth operation example is an example in which the mobile IAB node 300M gives a notification that the node is a mobile IAB node itself when connecting to a cell. To be more specific, the information about the mobile relay node (for example, the mobile IAB node 300M) is information indicating that the node is the mobile relay node itself. The mobile relay node transmits the information indicating that the node is the mobile relay node itself to the cell to which the mobile relay node has connected.

The donor node 200 having received the information indicating that the node is the mobile relay node itself can ascertain that the mobile IAB node 300M connected thereto. When the donor node 200 has ascertained whether the cell having received the information is a cell managed by the donor node 200 itself or a cell managed by the intermediate IAB node 300S, the donor node can properly perform processing for the mobile IAB node 300M. For example, the CU of the donor node 200 may determine to accept the connection if the mobile IAB node 300M connected to the cell managed by the DU of the donor node 200. For example, if the mobile IAB node 300M connected to the cell managed by the intermediate IAB node 300S, the CU of the donor node 200 can determine to perform a handover to the cell managed by the DU of the donor node 200. This allows the mobile IAB node 300M to properly connect to the donor node 200.

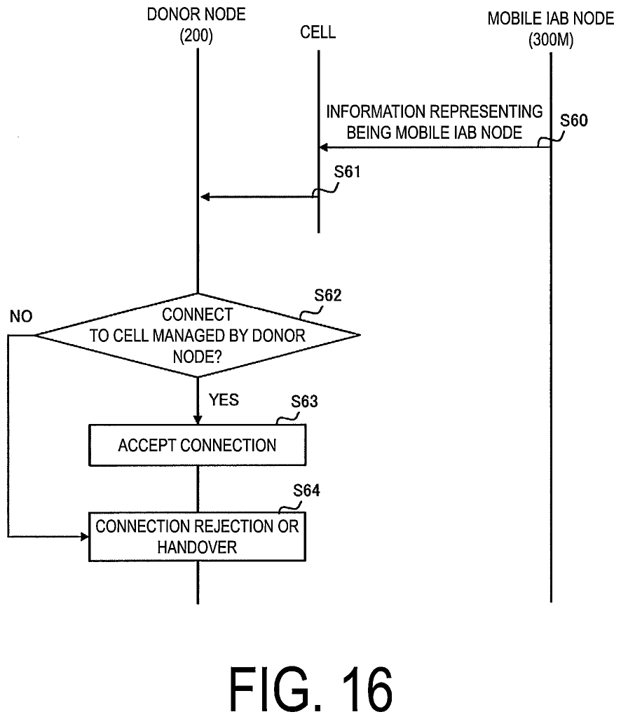

FIG. 16 is a diagram illustrating an operation example according to the sixth operation example.

As illustrated in FIG. 16, in step S60, the mobile IAB node 300M transmits a message including information indicating that it is the mobile IAB node itself to the cell when connecting to the cell. The message may be a message 3 (Msg3) (RRCSetupRequest message) in a random access procedure. Alternatively, the message may be a message 5 (Msg5) (RRCSetupComplete message). Alternatively, the message may be a UE capability information (UECapabilityInformation) message. When the information is included in the UE capability information message, the notification to the cell is delayed as compared with when the information is included in Msg3 or Msg5. Therefore, the method of including the information in Msg3 or Msg5 is preferred.

The cell to which the mobile IAB node 300M connected may be a cell managed by the donor node 200. The cell may be the cell managed by the intermediate IAB node 300S.

In step S61, the cell having received the information indicating that the node is the mobile IAB node (the cell managed by the DU of the donor node 200 or the cell managed by the IAB-DU of the intermediate IAB node 300S) transmits, for example, an F1 message including information indicating that the information has been received to the CU of the donor node 200.

In step S62, the CU of the donor node 200 determines whether the mobile IAB node 300M has connected to the cell managed by the donor node 200. Upon receiving the F1 message including the information indicating that the node is the mobile IAB node, the CU of the donor node 200 checks whether the F1 connection of the F1 message is the DU of the donor node 200 or the IAB-DU of the intermediate IAB node 300S to determine whether the mobile IAB node 300M has connected to the cell managed by the donor node 200.

If the CU of the donor node 200 determines that the mobile IAB node 300M has connected to the cell managed by the donor node 200 (i.e., the F1 connection is the DU of the donor node 200) (YES in step S62), the processing proceeds to step S63. On the other hand, if the CU of the donor node 200 determines that the mobile IAB node 300M has not connected to the cell managed by the donor node 200 (i.e., the F1 connection is the IAB-DU of the intermediate IAB node 300S) (NO in step S62), the processing proceeds to step S64.

In step S63, the CU of the donor node 200 may accept the connection of the mobile IAB node 300M.

On the other hand, in step S64, first, the CU of the donor node 200 may reject the connection of the mobile IAB node 300M. In this case, the CU of the donor node 200 transmits an F1 message including the information indicating rejection of a connection of the mobile IAB node 300M to the IAB-DU of the intermediate IAB node 300S. The IAB-DU of the intermediate IAB node 300S may reject a connection by transmitting an RRC rejection (RRCReject) message or an RRC release (RRCRelease) message to the IAB-MT of the mobile IAB node 300M via a message 4 (Msg4).

In step S64, second, the CU of the donor node 200 may cause the mobile IAB node 300M to be handed over to the cell managed by the donor node 200. In this case, the CU of the donor node 200 transmits an F1 message including an RRC reconfiguration (HO Command) message to the IAB-DU of the intermediate IAB node 300S. Then, the IAB-DU of the intermediate IAB node 300S may transmit an RRC reconfiguration (HO command) message to the IAB-MT of the mobile IAB node 300M in response to the reception of the F1 message.

Note that the sixth operation example is applicable without being limited to the first scenario. That is, the mobile IAB node 300M only needs to be able to transmit information indicating that the node is the mobile IAB node 300M itself to the cell when connecting to the cell, and also be applicable to the second scenario (the scenario in which the mobile IAB node 300M can also connect to the intermediate IAB node).

### (2.2) Seventh Operation Example

The seventh operation example will be described.

In the seventh operation example, an example in which the donor node 200 restricts the mobile IAB node 300M for F1 setup will be described. To be more specific, when the mobile relay node (for example, the mobile IAB node 300M) connects to the cell managed by the intermediate relay node (for example, the intermediate IAB node 300S) that is stationary without movement, the donor node (for example, the donor node 200) transmits F1 setup request transmission prohibition information indicating that the transmission of an F1 setup request message is prohibited to the mobile relay node.

Thus, for example, even if the mobile IAB node 300M can connect to the cell managed by the intermediate IAB node 300S, it cannot transmit the F1 setup request (F1 SETUP REQUEST) message, so the F1 connection cannot be established, and the F1 connection with the donor node 200 is restricted. For this reason, the mobile IAB node 300M cannot operate (for example, cannot move) as a mobile IAB node. In this case, the donor node 200 causes the mobile IAB node 300M to hand over to the cell managed by the donor node 200, so the mobile IAB node 300M can connect to the cell. Thus, the mobile IAB node 300M can properly connect to the donor node 200.

As described above, the seventh operation example is an example in which the mobile IAB node 300M is granted to connect to the intermediate IAB node 300S and the F1 connection is restricted, thereby restricting the operation as a mobile IAB node.

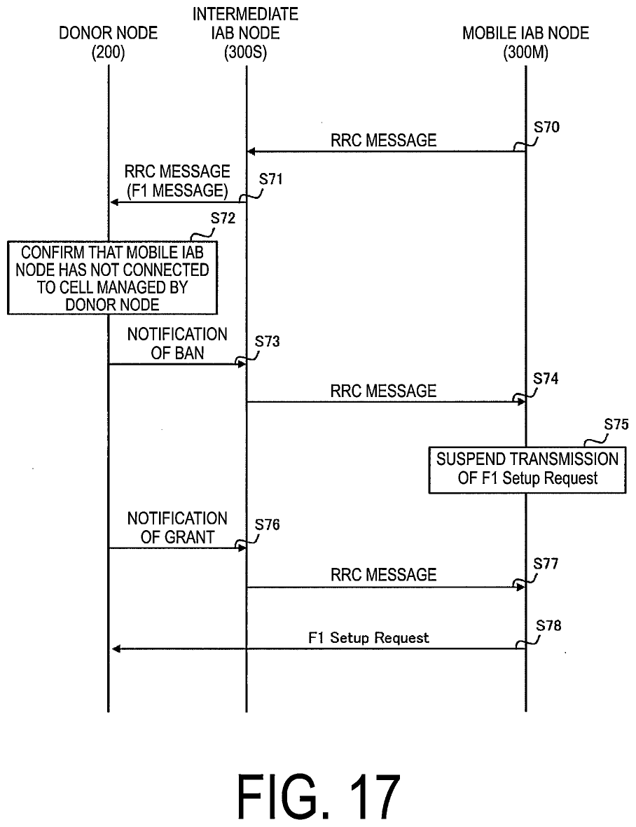

FIG. 17 is a diagram illustrating an operation example according to the seventh operation example.

As illustrated in FIG. 17, in step S70, the IAB-MT of the mobile IAB node 300M starts connection to the cell managed by the intermediate IAB node 300S and transmits an RRC message (for example, Msg3 (RRCSetupRequest message)) to the cell. As in the sixth operation example, the RRC message may include information indicating that the node is the mobile IAB node itself. In this case, also in the seventh operation example, the information about the mobile relay node (for example, the mobile IAB node 300M) is information indicating that the node is the mobile relay node itself.

In step S71, in response to the reception of the RRC message, the IAB-DU of the intermediate IAB node 300S transmits an F1 message including the RRC message to the CU of the donor node 200. In response to the reception of the RRC message, the IAB-DU of the intermediate IAB node 300S may transmit an F1 message including information indicating that the RRC message has been received to the CU of the donor node 200.

In step S72, the CU of the donor node 200 confirms that the F1 connection having received the F1 message is the IAB-DU of the intermediate IAB node 300S. For example, when the CU of the donor node 200 receives the F1 message, the CU checks the F1 connection of the F1 message to confirm the connection to the IAB-DU of the intermediate IAB node 300S. Thus, the CU of the donor node 200 confirms that the mobile IAB node 300M has connected to the cell managed by the intermediate IAB node 300S (or that the mobile IAB node 300M has not connected to the cell managed by the donor node 200).

In step S73, the CU of the donor node 200 transmits, to the IAB-DU of the intermediate IAB node 300S, an F1 message including F1 setup request transmission prohibition information indicating that transmission of the F1 setup request is prohibited. The F1 setup request transmission prohibition information may be included in an RRC message, and may be transmitted by including (or encapsulating) the RRC message in an F1 message.

In step S74, the IAB-DU of the intermediate IAB node 300S transmits, to the IAB-MT of the mobile IAB node 300M, an RRC message (e.g., an RRC reconfiguration (RRCReconfiguration) message) including F1 setup request transmission prohibition information. The IAB-MT of the mobile IAB node 300M outputs the F1 setup request transmission prohibition information to the upper layer (IAB-DU) of the mobile IAB node 300M.

In Step S75, the IAB-DU of the mobile IAB node 300M suspends transmission of an F1 setup request (F1 SETUP REQUEST) message in response to the reception of the F1 setup request transmission prohibition information.

In step S76, the CU of the donor node 200 transmits, to the IAB-DU of the intermediate IAB node 300S, an F1 message including F1 setup request transmission grant information indicating that transmission of the F1 setup request is granted (or the prohibition is canceled). For example, the CU of the donor node 200 generates an RRC message (e.g., an RRC reconfiguration message) including the F1 setup request transmission grant information. Then, the CU of the donor node 200 transmits an F1 message including the RRC message to the IAB-DU of the intermediate IAB node 300S. Note that the RRC message may be an HO command. In this case, the CU of the donor node 200 causes the mobile IAB node 300S connected to the cell managed by the IAB-DU of the intermediate IAB node 300S to perform handover.

In step S77, the IAB-DU of the intermediate IAB node 300S transmits an RRC message (for example, an RRC reconfiguration message) including the F1 setup request transmission grant information to the IAB-MT of the mobile IAB node 300M in response to the reception of the F1 message. The IAB-MT of the mobile IAB node 300M outputs the received F1 setup request transmission grant information to the upper layer (IAB-DU) of the mobile IAB node 300M.

Note that the F1 setup request transmission grant information may be implicit when notified. For example, the CU of the donor node 200 may generate an RRC message not including the F1 setup request transmission prohibition information. The mobile IAB node 300M may recognize that transmission of the F1 setup request has been granted in response to the reception of the RRC message not including the F1 setup request transmission prohibition information.

In step S78, the IAB-DU of the mobile IAB node 300M transmits an F1 setup request to the CU of the donor node 200 in response to the reception of the F1 setup request transmission grant information.

In the seventh operation example, the example (step S75) in which the mobile IAB node 300M suspends transmission of the F1 setup request in response to the reception of the F1 setup request transmission prohibition information has been described. For example, the F1 setup request transmission prohibition information may not be provided. In this case, the IAB-DU of the mobile IAB node 300M may be prohibited from transmitting the F1 setup request until the F1 setup request transmission grant information (step S77) is received. The IAB-DU of the mobile IAB node 300M can transmit an F1 setup request upon receiving the F1 setup transmission grant information (step S77). Therefore, the mobile IAB node 300M is not able to transmit an F1 setup request if the F1 setup request transmission grant information is not received at the time of being RRC-connected to the intermediate IAB node 300S. Also in such a case, when the mobile IAB node 300M is connected to the intermediate IAB node 300S, an F1 connection to the mobile IAB node 300M is restricted.

### (2.3) Eighth Operation Example

The eighth operation example will be described.

Regarding an F1 setting for the mobile IAB node 300M, there is a possibility that a new setting will be added in addition to the existing IAB setting. For example, if information indicating whether the mobile IAB node 300M can operate as a mobile IAB node can be transmitted in an F1 message, the donor node 200 can properly perform the F1 setting for the mobile IAB node 300M. For example, the donor node 200 can properly perform the F1 setting for the mobile IAB node 300M by imposing a restriction if the mobile IAB node 300M can operate as a mobile IAB node, or imposing no restriction if the mobile IAB node 300M does not operate as a mobile IAB node.

Therefore, in the eighth operation example, an example in which the mobile IAB node 300M transmits information indicating whether it can operate as a mobile IAB node to the donor node 200 in an F1 message will be described. Hereinafter, the information indicating whether the mobile IAB node 300M can operate as a mobile IAB node may be referred to as “operation possibility information”. The operation possibility information may be information indicating whether the mobile IAB node 300M operates as a mobile IAB node.

To be more specific, information about a mobile relay node (for example, the mobile IAB node 300M) is operation possibility information indicating whether the mobile relay node can operate as a mobile relay node. The mobile relay node transmits the operation possibility information to a donor node (e.g., the donor node 200).

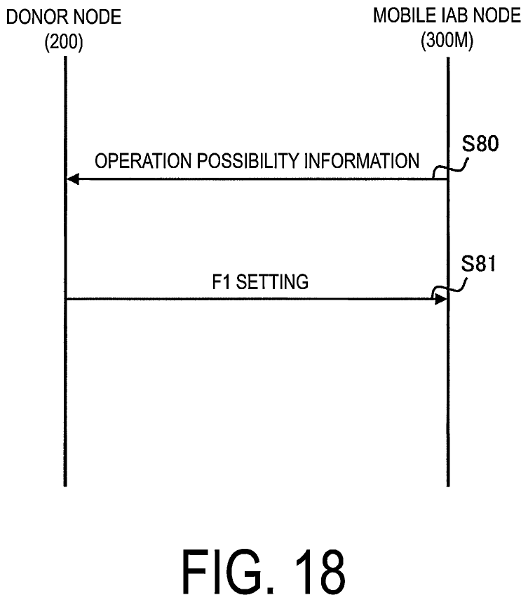

FIG. 18 is a diagram illustrating an operation example according to the eighth operation example. Note that, before the operation illustrated in FIG. 18 is started, the mobile IAB node 300M may be directly connected to the donor node 200. The mobile IAB node 300M may be connected to the donor node 200 via the intermediate IAB node 300S.

In step S80, the IAB-DU of the mobile IAB node 300M transmits an F1 message including operation possibility information to the CU of the donor node 200. The F1 message may be an F1 setup request (F1 SETUP REQUEST) message or a gNB-DU configuration update (gNB-DU CONFIGURATION UPDATE) message.

First, the mobile IAB node 300M may transmit information indicating that the mobile IAB node 300M has the capability of a mobile IAB node, instead of the operation possibility information.

Second, the mobile IAB node 300M may transmit information indicating that the mobile IAB node 300M prefers to operate as a mobile IAB node (preference), instead of the operation possibility information.

Third, the mobile IAB node 300M may transmit information indicating that the mobile IAB node 300M has been restricted to operating as a mobile IAB node, instead of the operation possibility information. That may be a case in which, for example, the mobile IAB node 300M is restricted to operating as the mobile IAB node 300M through an RRC message when the mobile IAB node connects to the intermediate IAB node 300S, or the like. In this case, the mobile IAB node 300M may connect to the intermediate IAB node 300S in the same/similar state as/to the intermediate IAB node which is stationary without movement by restricting the operation (for example, movement) as a mobile IAB node. When the mobile IAB node 300M transmits the information indicating that its operation as a mobile IAB node has been restricted, the mobile IAB node may transmit cause information together. The cause information may be information indicating a connection to the intermediate IAB node 300S. The cause information may be information indicating a problem of the capability of a radio layer.

Fourth, the mobile IAB node 300M may transmit information indicating that the operation as a mobile IAB node is not restricted (or restriction is canceled), instead of the operation possibility information. For example, the restriction on the mobile IAB node 300M is canceled through an RRC message (for example, step S77 in the seventh operation example).

In step S81, the donor node 200 performs an appropriate F1 setting for the mobile IAB node 300M based on the operation possibility information.

### (2.4) Ninth Operation Example

The ninth operation example will be described.

The ninth operation example is an example in which the mobile IAB node 300M transmits information for specifying an RRC connection to the donor node 200 with an F1 message.

For example, it is assumed that the mobile IAB node 300M performs an RRC connection establishment (RRC connection Establishment) procedure for the donor node 200 to establish an RRC connection to the donor node 200. For example, it is assumed that the mobile IAB node 300M performs an F1 setup (F1 Setup) procedure on the donor node 200 to establish an F1 connection to the donor node 200. Note that, in this case, the CU of the donor node 200 has two entities of an RRC connection and an F1 connection.

In such a case, the donor node 200 may recognize the RRC connection as of the mobile IAB node 300M on the RRC side (that is, the CU of the donor node 200), but not recognize the F1 connection as the mobile IAB node 300M on the F1 side (that is, the CU of the donor node 200).

In the ninth operation example, an example in which a mobile relay node (e.g., the mobile IAB node 300M) transmits an F1 message including information for specifying an RRC connection (hereinafter, which may be referred to as “RRC connection specifying information”) to a donor node (e.g., the donor node 200) will be described. In the ninth operation example, the information about a mobile relay node is RRC connection specifying information indicating information for specifying the RRC connection of the mobile relay node to the donor node.

As a result, for example, the donor node 200 can associate the information about the F1 connection of the mobile IAB node 300M with the information about the RRC connection of the mobile IAB node 300M using the RRC connection specifying information received in the F1 connection. Then, the donor node 200 can recognize that the mobile IAB node 300M is connected also on the F1 side by the association, and can set an F1 setting for the mobile IAB node 300M. The mobile IAB node 300M can properly connect to the donor node 200 by receiving an appropriate F1 setting from the donor node 200.

Note that, in the following description, information about the F2 connection of the mobile IAB node 300M may be referred to as “F1 context” (F1 context). Information about the RRC connection of the mobile IAB node 300M may be referred to as “RRC context” (RRC context).

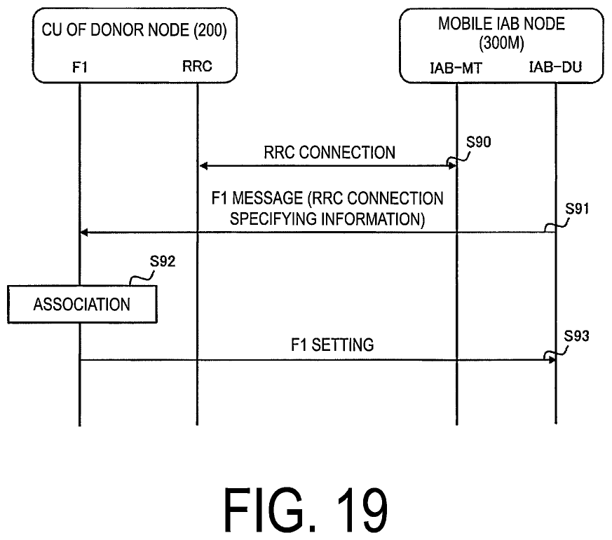

FIG. 19 is a diagram illustrating an operation example according to the ninth operation example.

As illustrated in FIG. 19, in step S90, the IAB-MT of the mobile IAB node 300M performs an RRC connection establishment procedure to establish an RRC connection to (the RRC entity of) the CU of the donor node 200. The IAB-MT of the mobile IAB node 300M may output the RRC connection specifying information to an upper layer (IAB-DU) of the mobile IAB node 300M.

In step S91, the IAB-DU of the mobile IAB node 300M performs an F1 setup procedure to establish an F1 connection to (the F1 entity of) the CU of the donor node 200. When an F1 connection is established, the IAB-DU of the mobile IAB node 300M transmits an F1 message including RRC connection specifying information to (the F1 entity of) the CU of the donor node 200. The F1 message is, for example, an F1 setup request (F1 SETUP REQUEST) message. The F1 message includes, for example, F1 context.

The RRC connection specifying information may be a Cell-Radio Network Temporary Identifier (C-RNTI). The C-RNTI is identification information used to identify the mobile IAB node 300M from another IAB node (or UE 100). The C-RNTI is issued by the donor node 200 and is used during an RRC connection.

The RRC connection specifying information may further include a cell ID of a cell to which the mobile IAB node 300M has connected.

Second, the RRC connection specifying information may be an RRC transaction ID (RRC-TransactionIdentifier) of the RRC message. The RRC transaction ID is identification information used to identify each RRC procedure. The RRC transaction ID is issued by the donor node 200, for example. The RRC transaction ID is one of the information elements (IEs) included in the RRC message.

In step S92, in response to the reception of the F1 message, the CU of the donor node 200 associates F1 context with RRC context using the RRC connection specifying information. For example, the CU of the donor node 200 reads RRC context having the same C-RNTI as the C-RNTI included in the F1 message from the memory and associates the read RRC context with the F1 context included in the F1 message. If the RRC context includes the information indicating that the IAB node connecting to the donor node 200 is the mobile IAB node 300M, the donor node 200 can recognize that the mobile IAB node 300M has connected to the donor node 200 also on the F1 side by the association.

In step S93, the CU of the donor node 200 performs a proper F1 setting on the IAB-DU of the mobile IAB node 300M in consideration of the RRC state of the mobile IAB node 300M.

### Third Embodiment

A third embodiment will be described.

The second embodiment has described that the mobile IAB node 300M is granted to connect to the intermediate IAB node 300S, and even in such a case, the handover to the cell managed by the donor node 200 is performed. In the third embodiment, a handover of the mobile IAB node 300M will be mainly described.

In order to cause the mobile IAB node 300M to perform handover to the cell managed by the donor node 200, the donor node 200 needs to select a target cell from the cells managed by the donor node 200. This is because, if the donor node 200 selects the cell managed by the intermediate IAB node 300S as a target cell, the mobile IAB node 300M is not able to connect to the donor node 200.

Even if the cell to which the mobile IAB node 300M has currently connected is a cell managed by the donor node 200 (source donor node), when the mobile IAB node 300M performs handover, the cell managed by the donor node 200 (target donor node) needs to be a target cell.

As described above, the handover destination of the mobile IAB node 300M also needs to be a cell managed by the donor node 200.

On the other hand, if a target donor node 200T is not able to accept a connection of the mobile IAB node 300M, the target donor node rejects the handover request (HO REQUEST) from a source donor node 200S. In such a case, a handover delay (Too Late Handover) may occur while the source donor node 200S is performing processing on another donor node 200 serving as a target.

The third embodiment aims to enable the mobile IAB node 300M to properly hand over to the donor node 200. If the mobile IAB node 300M can properly hand over to the donor node 200, the mobile IAB node 300M can properly connect to the donor node as in the first embodiment.

Note that, in the following description, movement (migration) of the mobile IAB node 300M and a handover (Handover) of the mobile IAB node 300M may be used without distinction, as described above. For example, a handover request may be read as a movement request.

In the third embodiment, operation examples will be described in the following order.

(3.1) Tenth operation example: The source donor node 200S transmits, to the target donor node 200T, information indicating a handover of the mobile IAB node 300M.

(3.2) 11th operation example: A first donor node 200-1 transmits information indicating whether a handover of the mobile IAB node 300M is acceptable to a second donor node 200-2 as an adjacent donor node.

### (3.1) Tenth Operation Example

With respect to the target donor node 200T, there is a possibility of a target cell to be selected changing depending on whether a handover target is the mobile IAB node 300M. As described above, the target donor node 200T needs to set a cell managed by the target donor node 200T as a target cell.

In the tenth operation example, first, the source donor node (e.g., the source donor node 200S) transmits a handover request message including information indicating that the mobile relay node (e.g., the mobile IAB node 300M) is a handover target to the target donor node (e.g., the target donor node 200T). Second, the target donor node selects a cell managed by the target donor node as a handover destination cell of the mobile relay node in response to the reception of the handover request message.

As described above, since a cell managed by the target donor node 200T is a target cell, the handover destination of the mobile IAB node 300M is a cell managed by the donor node 200. Thus, the mobile IAB node 300M can properly hand over to the donor node 200.

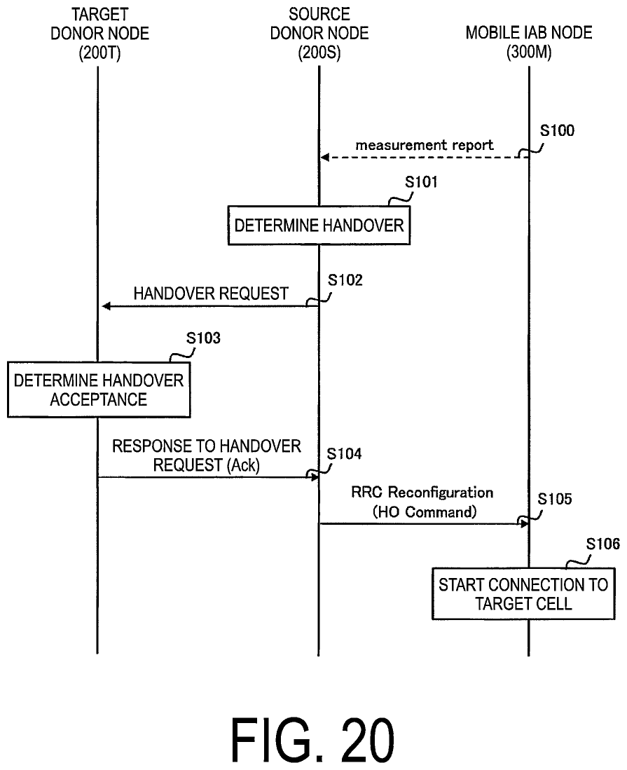

FIG. 20 is a diagram illustrating an operation example according to the tenth operation example. In FIG. 20, it is assumed that the mobile IAB node 300M has connected to the donor node (source donor node 200S).

As illustrated in FIG. 20, the mobile IAB node 300M may transmit a measurement report to the source donor node 200S in step S100.

In step S101, the source donor node 200S determines a handover of the mobile IAB node 300M.

In step S102, the source donor node 200S transmits a handover request (HANDOVER REQUEST) message to the target donor node 200T. The handover request message includes information indicating that the handover target is the mobile IAB node 300M. The handover request message is one of Xn messages.

In step S103, the target donor node 200T determines to accept the handover request according to the handover request message. At this time, the CU of the target donor node 200T selects a cell managed by the DU of the target donor node 200T as a target cell based on information indicating that the handover target is the mobile IAB node 300M. In other words, the CU of the target donor node 200T does not select (or excludes) the cell managed by the DU of the subordinate intermediate IAB node 300S as a target cell based on the information indicating that the handover target is the mobile IAB node 300M.

In step S104, the target donor node 200T transmits a handover request acknowledgment (HANDOVER REQUEST ACKNOWLEDGE) message to the source donor node 200S. For example, the target donor node 200T generates an RRC reconfiguration (HO command) message including configuration information for the mobile IAB node 300M to connect to the target cell, and transmits the handover request acknowledgment message including the RRC reconfiguration (HO command) message to the source donor node 200S. The handover request acknowledgment message is one of Xn messages. The RRC reconfiguration (HO command) message includes the cell ID of the target cell.

In step S105, the source donor node 200S transmits the RRC reconfiguration (HO command) message to the mobile IAB node 300M in response to the reception of the handover request acknowledgment message.

In step S106, the mobile IAB node 300M starts a connection to the target cell in response to the reception of the RRC reconfiguration (HO command) message.

### (3.2) 11th Operation Example

The 11th operation example will be described.

The 11th operation example is an example in which the first donor node 200-1 transmits information indicating whether a handover of the mobile IAB node 300M is acceptable to the second donor node 200-2 as an adjacent donor node.

To be more specific, first, the target donor node (e.g., the first donor node 200-1) transmits mobile relay node acceptability information indicating whether the mobile relay node (e.g., the mobile IAB node 300M) can be accepted to the source donor node (e.g., the second donor node 200-2). Second, the source donor node transmits a handover request message to the target donor node based on the mobile relay node acceptability information.

Thus, for example, the source donor node (second donor node 200-2) can determine whether the target donor node (first donor node 200-1) accepts a handover of the mobile IAB node 300M based on the mobile relay node acceptability information. The source donor node may limit the cells to be measured to cells acceptable by the mobile IAB node 300M in the measurement configuration of the mobile IAB node 300M.

The source donor node (second donor node 200-2) can transmit a handover request message to the first donor node 200-1 as a donor node capable of accepting the handover of the mobile IAB node 300M.

Thus, the source donor node (second donor node 200-2) can avoid a handover delay (Too Late Handover) caused by the handover request being rejected after the handover request message is transmitted. Therefore, the mobile IAB node 300M can properly perform a handover, and also properly connect to the target donor node (the first donor node 200-1).

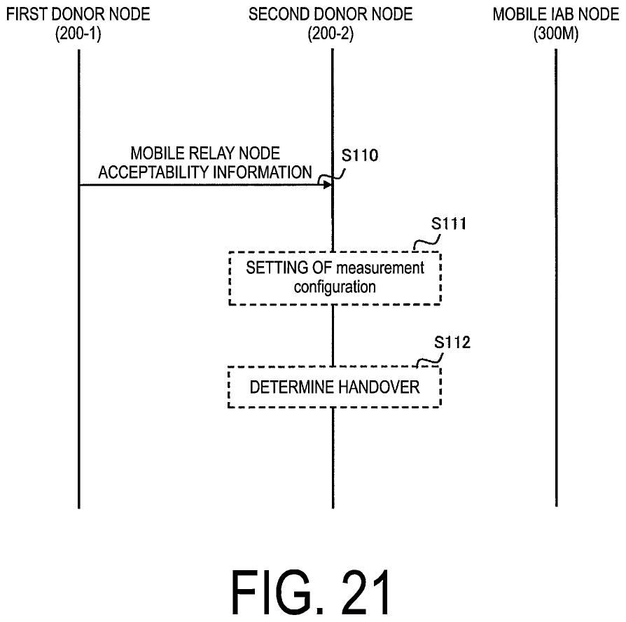

FIG. 21 is a diagram illustrating an operation example according to the 11th operation example. In FIG. 21, the first donor node 200-1 and the second donor node 200-2 are, for example, donor nodes 200 adjacent to each other. The first donor node 200-1 may be a target donor node of the mobile IAB node 300M. The second donor node 200-2 may be a source donor node to which the mobile IAB node 300M is currently connected.

As illustrated in FIG. 21, in step S110, the first donor node 200-1 transmits an Xn message including mobile relay node acceptability information to the second donor node 200-2. The mobile relay node acceptability information is information indicating whether the first donor node 200-1 can accept the mobile IAB node 300M or whether the first donor node 200-1 cannot accept the mobile IAB node 300M. The mobile relay node acceptability information may include a list of cell IDs of acceptable cells. Alternatively, the mobile relay node acceptability information may include a list of cell IDs of unacceptable cells. Whether a cell is acceptable or unacceptable is determined based on whether a cell is managed by the donor node 200 (first donor node 200-1). Alternatively, whether a cell is acceptable or unacceptable may be determined based on whether the cell is managed by the intermediate IAB node 300S. Note that, prior to step S110, the second donor node 200-2 may request the first donor node 200-1 to provide the mobile relay node acceptability information. The second donor node 200-2 may make the request by transmitting an Xn message including the request to the first donor node 200-1.

In step S111, the second donor node 200-2 may configure a measurement configuration for the mobile IAB node 300M by using the mobile relay node acceptability information. For example, the second donor node 200-2 performs the configuration by transmitting, to the mobile IAB node 300M, an RRC message including a measurement configuration in which a cell capable of accepting the mobile IAB node 300M is a measurement object.

In step S112, the second donor node 200-2 (source donor node) may determine a handover of the mobile IAB node 300M and determine the donor node 200 to which a handover request (HANDOVER REQUEST) message is to be transmitted based on the mobile relay node acceptability formation. That is, the second donor node 200-2 may determine a donor node (or a target donor node) managing a cell capable of accepting the mobile IAB node 300M by using the mobile relay node acceptability information.

### Other Embodiments

A program causing a computer to execute each processing operations performed by the UE 100, the gNB 200, or the IAB node 300 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing each processing operations performed by the UE 100, the gNB 200, or the IAB node 300 may be integrated, and at least part of the UE 100 or the gNB 200 may be configured as a semiconductor integrated circuit (a chipset or a System on a Chip (SoC)).

The phrases “based on” and “depending on” used in the present disclosure do not mean “based only on” and “only depending on”, unless specifically stated otherwise. The phrase “based on” means both “based only on” and “based at least in part on”. The phrase “depending on” means both “only depending on” and “at least partially depending on”. The terms “include”, “comprise”, and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure. The embodiments, the operation examples, or the processing operations may be combined as appropriate as long as they are not inconsistent with each other.

### First Supplementary Note

### Supplementary Note 1

A communication control method used in a cellular communication system, the communication control method includes transmitting, by one of a donor node or an intermediate relay node being stationary without movement, information about a mobile relay node.

### Supplementary Note 2

The communication control method described in supplementary node 1, in which the information about the mobile relay node is connection grant information indicating that a connection of the mobile relay node is granted, and the transmitting includes broadcasting, by the donor node, the connection grant information.

### Supplementary Note 3

The communication control method described in supplementary note 1 or supplementary note 2, further including setting, by the mobile relay node, a cell having broadcast the connection grant information as a selection candidate cell in a cell selection procedure.

### Supplementary Note 4

The communication control method described in any one of supplementary notes 1 to 3, in which the information about the mobile relay node is connection rejection information indicating that a connection of the mobile relay node is not granted, the communication control method further including broadcasting, by the intermediate relay node, the connection rejection information.

### Supplementary Note 5

The communication control method described in supplementary notes 1 to 4, further including excluding, by the mobile relay node, a cell having broadcast the connection rejection information from selection candidate cells in a cell selection procedure.

### Supplementary Note 6

The communication control method described in any one of supplementary notes 1 to 5, in which the information about the mobile relay node is connectable cell information indicating a cell to which the mobile relay node is able to connect, and the transmitting includes transmitting, by one of the donor node or the intermediate relay node, the connectable cell information to the mobile relay node.

### Supplementary Note 7

The communication control method described in any one of supplementary notes 1 to 6, in which the information about the mobile relay node is non-connectable cell information indicating a cell to which the mobile relay node is not able to connect, and the transmitting includes transmitting, by at least one of the donor node and the intermediate relay node, the non-connectable cell information to the mobile relay node.

### Supplementary Note 8

The communication control method described in any one of supplementary notes 1 to 7, further including setting, by the mobile relay node, a cell indicated by the connectable cell information as a selection candidate cell in the cell selection procedure, and excluding a cell indicated by the non-connectable cell information from the selection candidate cells in the cell selection procedure.

### Supplementary Note 9

The communication control method described in any one of supplementary notes 1 to 8, in which the information about the mobile relay node is cell identification information included in one of a measurement configuration or a conditional reconfiguration, and the transmitting includes a transmitting, by the donor node, one of the measurement configuration and the conditional reconfiguration to the mobile relay node, the communication control method further including determining, by the mobile relay node, a cell indicated by the cell identification information included in one of the measurement configuration or the conditional reconfiguration to be a cell to which the mobile relay node can connect.

### Supplementary Note 10

The communication control method described in any one of supplementary notes 1 to 9, in which the information about the mobile relay node is resource information about a resource that the mobile relay node can use exclusively in a random access procedure, and the transmitting includes broadcasting, by the donor node, the resource information.

### Supplementary Note 11

The communication control method described in any one of supplementary notes 1 to 10, further including setting, by the mobile relay node, a cell having broadcast the resource information as a selection candidate cell in the cell selection procedure and performing the random access procedure with respect to a cell selected from the selection candidates cells by using the resource indicated by the resource information.

### Supplementary Note 12

A communication control method used in a cellular communication system, the communication control method including transmitting, by a mobile relay node, information about the mobile relay node.

### Supplementary Note 13

The communication control method described in supplementary note 12, in which the information about the mobile relay node is information indicating that the node is the mobile relay node itself, and the transmitting includes transmitting, by the mobile relay node, the information indicating that the node is the mobile relay node itself to a cell to which the mobile relay node has connected.

### Supplementary Note 14

The communication control method described in supplementary note 12 or supplementary note 13, further including transmitting, by a donor node, F1 setup request transmission prohibition information indicating that transmission of an F1 setup request is prohibited to the mobile relay node when the mobile relay node has connected to a cell managed by an intermediate relay node that is stationary without movement.

### Supplementary Note 15

The communication control method described in any one of supplementary notes 12 to 14, in which the information about the mobile relay node is operation possibility information indicating whether the mobile relay node is operable as the mobile relay node, and the transmitting includes transmitting, by the mobile relay node, the operation possibility information to a donor node.

### Supplementary Note 16

The communication control method described in any one of supplementary notes 12 to 15, in which the information about the mobile relay node is RRC connection specifying information indicating information for specifying an RRC connection of the mobile relay node to a donor node, and the transmitting includes transmitting, by the mobile relay node, an F1 message including the RRC connection specifying information to the donor node.

### Supplementary Note 17

A communication control method used in a cellular communication system, the communication control method including transmitting, by a source donor node, a handover request message to a target donor node, the handover request message including information indicating that a mobile relay node is a handover target, and selecting, by the target donor node, a cell managed by the target donor node as a handover destination cell of the mobile relay node in response to reception of the handover request message.

### Supplementary Note 18

The communication control method described in supplementary note 17, further including transmitting, by the target donor node, mobile relay node acceptability information indicating whether the mobile relay node is acceptable to the source donor node, in which transmitting of the handover request message includes transmitting, by the source donor node, the handover request message to the target donor node based on the mobile relay node acceptability information.

### Second Supplementary Note

### 1. Introduction

A new work item for mobile IAB has been approved in RAN #94e. Specific objects of WI are as follows.
To define migration/topology adaptation procedures to realize IAB node mobility, including inter-donor migration of an entire mobile IAB node (full migration).
To strengthen the mobility of IAB nodes and their UE, including aspects related to group mobility. Optimization to target peripheral UE.
Note that, although touching topics already discussed in Rel-17 or excluded from Rel-17 should be avoided in solutions, feature enhancement specialized in IAB node mobility is an exception.
To mitigate interference due to IAB node mobility, including avoidance of potential collisions of reference signals and control signals (PCI, RACH, etc.).

Note that, at the beginning of the working period, RAN3 and RAN2 should discuss the potential complexity of a scenario in which a mobile IAB node connects to a stationary (intermediate) IAB node, in comparison to a scenario in which a mobile IAB node connects directly to an IAB donor.

In this supplementary note, the complexity in two topology scenarios is analyzed from the perspective of RAN2.

### 2. Discussion

### 2.1 Scenario

The WID explicitly assumes that a mobile IAB node has no descendant IAB nodes, as follows.

In Rel-18, a mobile IAB node supports the following functions applied to FR1 and FR2.
In-band and out-of-band backhaul.
The mobile IAB node has no descendant IAB nodes and provides services only to UE.
The solution is to support HO and DC of the UE.

Since the mobile IAB node provides services only to the UE, that the mobile IAB node is always an access IAB node is clarified.

Proposal 1: RAN2 should make sure that a mobile IAB node is always an access IAB node.

WID states that an intermediate IAB node should be stationary. On the other hand, the question in RAN #96 is whether a mobile IAB node can only connect to an IAB donor or can also connect to an (intermediate) IAB node. Therefore, the two scenarios can be indicated as illustrated in FIGS. 9 and 10, respectively.

Some companies believe that the complexity will reduce if a mobile IAB node connects only to an IAB donor, while others claim that the complexity rather increases due to such a restriction. Thus, the complexity of each scenario will be discussed in the next section.

Observation 1: Complexity needs to be analyzed for a scenario in which a mobile IAB node can connect only to an IAB donor or can also connect to an intermediate IAB node.

### 2.2 Complexity Analysis

### 2.2.1 Deployment and Coverage

In general, Rel-16/17IAB was introduced to aid the efficient establishment of national coverage, particularly to expand FR2 deployment. If a mobile IAB node can connect only to an IAB donor, there will be a lot of coverage holes from the mobile IAB node's point of view because a cell provided by the IAB node is not available to the mobile IAB node.

When the mobile IAB node is disconnected from a network, it is obvious that the service to the UE cannot be continued, and therefore, if there are many coverage holes, many service interruptions directly occur. Assuming that the mobile IAB node is regarded as a network node in the same way as the IAB node of Rel-16/17, such service interruption is not preferred.

In order to realize a mobile IAB in scenario 1, in addition to the existing (or normal) deployment policy, a special deployment policy is required to ensure a coverage suitable for the mobile IAB node. On the other hand, in scenario 2, more flexible deployment is possible. Therefore, there is a possibility that the number of problems in development increases in scenario 1 than in scenario 2.

Proposal 2: RAN2 should agree that, if a mobile IAB node connects only to an IAB donor (scenario 1), service continuity of the mobile IAB node may not be ensured because many coverage holes occur. Therefore, the problem of development increases.

2.2.2 Network Interface Procedure (RAN3 area)

For network interfaces such as F1AP and XNaP, some complexity is expected if a mobile IAB node can also connect to an intermediate IAB node (scenario 2).

A routing configuration (F1AP) requires the IAB donor to update the configuration as a mobile IAB node move into and out of IAB topology. For scenario 2, the IAB donor needs to update the routing configuration of each IAB node in the IAB topology, which may result in a complicated procedure and a waiting time for an F1 reconfiguration.

For migration of a mobile IAB node (XNaP), it is expected that there will be no significant difference between scenario 1 and scenario 2, although full migration between donors of the mobile IAB node and group mobility of the UE will be considered in RAN3. However, in scenario 1, some degree of information exchange is required between the IAB donors in order to transfer, to another donor, the cell that can accept the mobile IAB node, in other words, the cell to which the DU of the IAB donor provides a service. Such information is used by the IAB donor for a measurement configuration and handover determination.

Since a mobile IABWI is driven by RAN3, the complexity of the network interface has already been intended to some degree in comparison to another interface handled in a secondary working group (including RAN2). Whether the network interface can support scenario 2 or whether another working group is instructed to define the mechanism of scenario 1 is up to RAN3 anyway.

Observation 2: If a mobile IAB node connects only to an IAB donor (i.e., scenario 1), the network interface procedure may be simpler. Details are up to RAN3.

2.2.3 Uu interface procedure (RAN2 area)

With respect to a UAU interface, some degree of complexity is expected if a mobile IAB node can connect only to an intermediate IAB node (i.e., scenario 1).

For initial access, it should be discussed whether a mobile IAB node can initiate an RRC connection establishment procedure to connect to a cell provided by an intermediate IAB node. Although an option that a mobile IAB node is only granted to establish a connection only to a cell provided by an IAB donor DU is conceivable, in this case, how the mobile IAB node can ascertain whether a cell is the cell provided by the IAB donor DU is a question. On the other hand, if a mobile IAB node is regarded as a network node, there is also the option that the mobile IAB node can establish a connection to any cell. Thus, a mobile IAB node may also connect to a cell provided by an intermediate IAB node, for example, for an OAM connection. However, since the mobile IAB node cannot connect to such a cell in scenario 1 in that case, if the node connects to a cell provided by the intermediate IAB node, the node is not supposed to operate as a mobile IAB node and may be controlled (i.e., restricted) in some way by the network.

Proposal 3: If a mobile IAB node is only granted to connect to an IAB donor (scenario 1), considering that the mobile IAB node is a network node, it should be discussed in the RAN2 whether the mobile IAB node needs to be restricted to attempting to connect to the IAB donor DU only.

It should be discussed whether the mobile IAB node should inform the IAB-donor that initial access is access to the mobile IAB node, as in the existing IAB node indication in Msg5. Such an indication may be necessary regardless of the scenarios, but particularly in scenario 1, the IAB donor needs to determine whether the IAB node can continue to connect to the cell depending on whether the cell is provided by the IAB donor DU or the IAB-DU of the intermediate IAB node. In other words, such an indication is more important in scenario 1.

Proposal 4: In particular, if a mobile IAB node only connects to an IAB donor (scenario 1), RAN2 should discuss whether the mobile IAB node needs to transmit a new indication (such as an indication of the mobile IAB node) in the RRC connection establishment procedure.

Since only fixed IAB nodes were assumed in Rel-16/17, the radio conditions of the backhaul link are considered to be stable. On the other hand, since a mobile IAB node is assumed in Rel-18, an RLF and an RRC reestablishment are not rare cases. When the mobile IAB node initiates RRC reestablishment, the IAB-MT first performs cell selection. In case of scenario 1, if the mobile IAB node selects a cell provided by the intermediate IAB node, the next RRC reestablishment may fail, or at least the mobile IAB node may not operate as a mobile IAB node after the RRC reestablishment because it cannot connect to the cell provided by the intermediate IAB node. This causes service interruption for the UE. Therefore, scenario 1 is optimized such that the mobile IAB node preferentially selects the cell provided by the IAB donor UE.

Proposal 5: If the mobile IAB node connects only to the IAB donor (scenario 1), RAN2 should discuss whether the RRC reestablishment procedure is optimized such that the mobile IAB node selects a mobile IAB-compatible cell.

On the other hand, if the mobile IAB node can also connect to the intermediate IAB node (scenario 2), no special processing is required because the mobile IAB node can connect to any cell.

Note that functional enhancement for use cases common to both scenarios are not excluded. “No special treatment” is intended to be applied only to comparison between scenarios.

Observation 3: If the mobile IAB node also connects to the intermediate IAB node (scenario 2), the mobile IAB node can connect to any cell (cells provided by the IAB donor DU and the intermediate IAB node), so no special processing is required for access of the mobile IAB node.

### 2.3 Overview

The overview of the above discussion is as follows.

TABLE 1
Summary of complexity of each scenario

| | Scenario 1 | Scenario 2 |
|---|---|---|
| | The mobile IAB node connects to | The mobile IAB node also connects to |
| | the IAB donor only. | the intermediate IAB node. |
| Deployment | Challenging | Minimal effect |
| policy | The coverage provided by the | The mobile IAB node can take |
| | intermediate IAB node cannot be | advantage of the existing coverage. |
| | used. | |
| F1 | Minimal effect | Complex |
| complexity | | The routing setting needs to be updated |
| | | for each IAB node in topology. |
| Xn | No big difference in scenarios. | No big difference in scenarios. |
| complexity | | |
| Uu | Complex | Minimal effect |
| | It may be necessary to limit or | No special handling of the mobile IAB |
| | optimize access attempts of the | node is assumed. |
| | mobile IAB node. | |

As shown in Table 1, there are advantages and disadvantages in the scenarios. Scenario 1 is superior in terms of F1 complexity, and scenario 2 is superior in terms of deployment policy and Uu complexity. Scenario 2 is somewhat desirable, especially from the viewpoint of RAN2. However, the final decision may be made by the major working group, namely RAN3.

Proposal 6: Although the adoption of the mobile IAB node also connecting to the intermediate IAB node (i.e. scenario 2) will have less impact on the specification of RAN2, the final decision should be entrusted to RAN3.

1. A communication control method used in a cellular communication system, the communication control method comprising the steps of:
transmitting, by a source donor node, a handover request message to a target donor node, the handover request message comprising information indicating that a mobile relay node is a handover target; and
selecting, by the target donor node, a cell managed by the target donor node as a handover destination cell of the mobile relay node in response to reception of the handover request message.

2. The communication control method according to claim 1, further comprising transmitting, by the target donor node, mobile relay node acceptability information indicating whether the mobile relay node is acceptable to the source donor node,
wherein the transmitting of the handover request message comprises transmitting, by the source donor node, the handover request message to the target donor node based on the mobile relay node acceptability information.

3. A target donor node comprising:
a receiver configured to receive a handover request message from a source donor node, the handover request message comprising information indicating that a mobile relay node is a handover target, and
a controller configured to select a cell managed by the target donor node as a handover destination cell of the mobile relay node in response to reception of the handover request message.

4. A communication system comprising a source node, a target donor node and a mobile relay node, wherein
the source donor node is configured to transmit a handover request message to the target donor node, the handover request message comprising information indicating that a mobile relay node is a handover target, and
the target donor node is configured to select a cell managed by the target donor node as a handover destination cell of the mobile relay node in response to reception of the handover request message.
